(19) United States
(12) Patent Application Publication
(10) Pub. No.: US 2026/0206747 A1
(43) Pub. Date: Jul. 23, 2026

(54) SOPHOROLIPIDS AND SOPHOROLIPID DERIVATIVES AS TANK MIX ADDITIVES AND ADJUVANTS IN CROP PROTECTION FORMULATIONS

(71) Applicant: Locus Solutions IPCO, LLC, Solon, OH (US)

(72) Inventors: Laurent Kieken, Solon, OH (US); Lee Speight, Solon, OH (US)

(21) Appl. No.: 19/141,259

(22) PCT Filed: Dec. 19, 2023
(86) PCT No.: PCT/US2023/084814

§ 371 Date: Jun. 19, 2025

Related U.S. Application Data
(60) Provisional application No. 63/434,533, filed on Dec. 22, 2022.

(51) Int. Cl. A01N 25/30; A01P 1/00; A01P 3/00; A01P 7/00

(52) U.S. Cl. CPC A01N 25/30; A01P 1/00; A01P 3/00; A01P 7/00

(57) ABSTRACT

The subject invention relates to the use of sophorolipids and novel sophorolipid derivatives as tank mix additives and/or adjuvants for pesticides, herbicides, fertilizers and other agricultural chemicals.

### CROSS-REFERENCE TO RELATED APPLICATION

This application claims priority to U.S. Provisional Patent Application No. 63/434,533, filed Dec. 22, 2022, which is incorporated herein by reference in its entirety.

### BACKGROUND OF THE INVENTION

In the agriculture industry, infections and infestations caused by bacteria, fungi, insects, nematodes and other pests and pathogens hinder the ability of farmers to maximize production yields while keeping costs low. Growers have relied heavily on the use of synthetic chemical pesticides to protect crops against pathogens, pests, and disease; however, when overused or improperly applied, these substances can pollute air and water through runoff, leaching and evaporation.

Mounting regulatory mandates governing the availability and use of chemicals, as well as consumer demands for residue free, sustainably grown food, necessitate a reevaluation of the impact on the environment in which that food and fiber is grown. Immediately eliminating the use of chemicals is not a viable option; however, improving the efficacy of those chemicals in order to, for example, reduce application rates is not only more environmentally-friendly, but also more cost effective.

In pest control compositions and in the industrial non-crop sector, compounds referred to as adjuvants are often employed for the purpose of improving the performance of pesticides or pesticide mixtures. Adjuvants are substances that are not usually themselves active as a pesticide but enhance or support the effectiveness of a pesticide. These substances are either added to spray solutions shortly before delivery (as a tank mix additive) or incorporated directly into crop protection product formulations.

Examples of adjuvants include surfactants, spreader stickers, crop oils, anti-foaming materials, buffering agents, and compatibility agents. Surfactants, in particular, are adjuvants that facilitate and accentuate the emulsifying, dispersing, spreading, wetting, or other surface modifying properties of liquids.

There are numerous crop protection active ingredients that only achieve acceptable efficacy, i.e., an effect with practical relevance, with the use of adjuvants. The adjuvants help to compensate for limitations of the active ingredient(s), such as, for example, the UV sensitivity, water instability, drift tendency, poor retention, poor uptake, and poor spreading and/or sticking over plant surfaces.

Additionally, many actives are not water-soluble, so adjuvants are important in aqueous solutions to provide effective distribution of the actives and to promote adequate wetting and coverage of the surfaces to which they are applied. Moreover, adjuvants help to overcome technical application problems, such as low water application volumes, varying water qualities, and increased application speeds.

Chemical residues from the foliar or soil application of pesticides, fungicides, herbicides, plant growth regulators, transfection agents, wood treatments, traps, disinfectants, surfactants and other synthetic products can alter microbial profiles and undermine plant growth and vitality. Research efforts have focused on achieving the maximum effectiveness of these chemicals; however, it is difficult to enhance the effectiveness of agricultural chemicals through adjustments in formulations, particularly when this results in lower concentrations or rates of application.

While the use of adjuvants is an important step in reducing chemical usage, or otherwise applying agricultural chemicals more efficiently, many adjuvants are themselves synthetic chemicals, for example, organosilicates, polyoxyethylene esters, ethoxy sulfates, petroleum by-products, complex alcohols, latex, alkyl polyglucosides, aliphatic alcohols, inorganic salts and polymerized resins.

Accordingly, in light of increasing environmental regulations and a general consumer desire for reducing chemical usage in agriculture, methods for lowering the effective amounts of pesticides and other agricultural chemical agents are needed. Further needed are more environmentally friendly, non-toxic adjuvants to use for such purposes.

### BRIEF SUMMARY OF THE INVENTION

The subject invention provides compositions and methods of their use for improving the efficacy of agricultural chemical applications, such as pesticides. More specifically, the subject invention provides for production, formulation and use of sophorolipids and novel sophorolipid derivatives as tank mix additives and/or adjuvants in agricultural applications. Advantageously, the compositions and methods of the subject invention are more environmentally friendly, less toxic and more cost-effective solutions to increasing the efficacy of pesticides and other agricultural chemicals compared to traditional adjuvants and tank mix additives.

In preferred embodiments, the subject invention provides adjuvant compositions comprising sophorolipids and/or derivatives thereof, which can serve as tank mix additives, formulating additives, or other adjuvant functions in agricultural and horticultural applications. In a specific exemplary embodiment, the agricultural and horticultural applications include crop and non-crop pest control; however, reference to “pesticides” and “pesticidal activity” herein is not meant to limit the invention only to pesticides. In other words, the subject adjuvant compositions can be useful for any agricultural chemical applications including, for example, fertilizers, herbicides, plant growth regulators, soil amendments and irrigation additives.

The adjuvant compositions of the subject invention preferably boost the performance of active agricultural chemical(s), e.g., pesticides, and/or enhance their activity, preferably by more than 5%, and more preferably by more than 10%, relative to use without the adjuvant composition. In certain embodiments, the application dosage of the adjuvant is between 1-5000 ml/ha, between 25-1000 ml/ha, or between 50-750 ml/ha.

The adjuvant compositions can be used as additives in formulations such as, for example, suspension concentrates, capsule suspensions, emulsifiable concentrates, water-soluble concentrates, oil dispersions, suspoemulsions, emulsions in water, water-dispersible granules or powders, alongside other added substances, such as, for example, dispersants, emulsifiers, thickeners, and defoamers, with an adjuvant content of 1% by weight to 99% by weight, 1.5% by weight to 60% by weight, or from 2.0% to 25% by weight. In certain preferred embodiments, the adjuvants are utilized as tank mix additives.

In some embodiments, due to the fermentation processes that can be utilized to produce sophorolipids, the adjuvant composition comprises a natural mixture of unpurified, or crude form, sophorolipid forms, including, for example, lactonic and linear form sophorolipids. This crude form can comprise residual fermentation components, cellular matter, reactants from the fermentation process, such as fatty acids and carbohydrates, nutrients, water and other natural impurities, especially organic impurities.

In other embodiments, the composition comprises sophorolipids that have been extracted from a fermentation broth, and, optionally, purified and/or subjected to further chemical modification or derivatization. For example, in certain embodiments, the composition is treated to remove impurities or residual materials from fermentation, such as glucose or fatty acids. Mixtures of sophorolipid forms can also be used.

In certain preferred embodiments, the composition comprises sophorolipids, wherein the sophorolipids are linear form sophorolipids. In certain specific embodiments, the composition does not contain lactonic sophorolipids.

In addition to, or as an alternative to, sophorolipids and derivatives thereof, the subject invention also envisions the use of other biosurfactants and/or derivatives thereof, including, for example, low molecular weight glycolipids (e.g., cellobiose lipids, rhamnolipids, mannosylerythritol lipids and trehalose lipids), lipopeptides (e.g., surfactin, iturin, fengycin, arthrofactin and lichenysin), flavolipids, phospholipids (e.g., cardiolipins), fatty acid esters, and high molecular weight polymers such as lipoproteins, lipopolysaccharide-protein complexes, and polysaccharide-protein-fatty acid complexes.

In some embodiments, the composition comprises sophorolipids and mannosylerythritol lipids. In yet other embodiments, the composition comprises sophorolipids and rhamnolipids. Other mixtures of biosurfactants are also envisioned.

In some embodiments, the subject invention provides agricultural compositions comprising the adjuvant composition of the subject invention and one or more agricultural chemicals selected from, for example, pesticides, herbicides, fertilizers, irrigation fluids, and plant growth regulators.

In some embodiments, use of the adjuvant composition with a pesticide produces a synergistic effect, wherein the total efficacy of the agricultural application comprising the adjuvant and the pesticide is greater than the efficacy of either component alone and/or greater than the expected combined efficacy of both components. The efficacy is relative both to the total amount and to the relative ratios. In some embodiments, a desired level of efficacy is obtained at a ratio of active ingredient to adjuvant of 1:100 to 50:1, or from 1:75 to 4:1.

In certain embodiments, the agricultural composition can comprise additional substances, such as, for example, carriers, pH adjusters, microbial inoculants, mineral sources, plant seeds, dyes, stabilizers, emulsifiers, prebiotics and/or polymers.

In some embodiments, the concentration at which the adjuvant composition is employed imparts no pesticidal activity itself, while in other embodiments, the adjuvant composition is employed at a concentration such that the adjuvant composition imparts a non-zero level of pesticidal activity.

The subject invention also provides methods for increasing the efficacy and/or reducing the toxicity of an active agricultural ingredient in comparison to the active agricultural ingredient when used alone, wherein an adjuvant composition of the subject invention is administered to a plant and/or the plant's surrounding environment either before, simultaneously with, or after the active agricultural ingredient The adjuvant and the active agricultural ingredient can be mixed together prior to administration to produce an agricultural composition according to embodiments of the subject invention. In some embodiments, the two components are applied individually but in such a way as to produce the agricultural composition at the point of administration.

The subject methods can improve efficacy of the active agricultural chemical by at least 15%, at least 20%, at least 25%, or at least 30%, compared with methods in which the chemical is applied without the adjuvant. Improved efficacy can include, for example, reduced dosage, greater pest control, increased plant yields, reduced water usage, and other quantitative or qualitative measures of efficacy.

### DETAILED DESCRIPTION OF THE INVENTION

The subject invention provides compositions and methods of their use for improving the efficacy of agricultural chemicals, such as pesticides, in ways that are more environmentally friendly, less toxic and more cost-effective solutions over traditional adjuvants and tank mix additives.

### Selected Definitions

As used herein, “agriculture” means the cultivation and breeding of plants for food, fiber, biofuel, medicines, cosmetics, supplements, ornamental purposes and other uses. According to the subject invention, agriculture can also include horticulture, landscaping, gardening, plant conservation, forestry and reforestation, pasture and prairie restoration, orcharding, arboriculture, and agronomy. Further included in agriculture are the care, monitoring and maintenance of soil.

As used herein, a “broth,” “culture broth,” or “fermentation broth” refers to a culture medium comprising at least nutrients and microorganism cells.

Unless the context requires otherwise, the phrases “fermenting,” “fermentation process” or “fermentation reaction” and the like, as used herein, are intended to encompass both the growth phase and product biosynthesis phase of the process.

As used herein, an “isolated” or “purified” compound is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. “Isolated” in the context of a microbial strain means that the strain is removed from the environment in which it exists in nature. Thus, the isolated strain may exist as, for example, a biologically pure culture, or as spores (or other forms of the strain) in association with a carrier.

As used herein, a “biologically pure culture” is a culture that has been isolated from materials with which it is associated in nature. In a preferred embodiment, the culture has been isolated from all other living cells. In further preferred embodiments, the biologically pure culture has advantageous characteristics compared to a culture of the same microbe as it exists in nature. The advantageous characteristics can be, for example, enhanced production of one or more growth by-products.

In certain embodiments, purified compounds are at least 60% by weight the compound of interest. Preferably, the preparation is at least 75%, more preferably at least 90%, and most preferably at least 99%, by weight the compound of interest. For example, a purified compound is one that is at least 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

As used herein, “enhancing” means improving or increasing. For example, in certain embodiments, enhancing efficacy of a pesticide can mean increasing the number of pests that are controlled by a given dosage of pesticide, reducing the dosage required for the pesticide to be effective, reducing off-target drift of the pesticide, increasing the retention of the pesticide on plant parts, increasing the penetration of a pesticide, increasing the wetting, coverage and uptake of the pesticide, increasing the stability of the pesticide during storage, and/or reducing the foam produced during mixing and/or application of the pesticide.

A “metabolite” refers to any substance produced by metabolism (e.g., a growth by-product) or a substance necessary for taking part in a particular metabolic process. A metabolite can be an organic compound that is a starting material, an intermediate in, or an end product of metabolism. Examples of metabolites include, but are not limited to, biosurfactants, biopolymers, enzymes, acids, solvents, alcohols, proteins, vitamins, minerals, microelements, and amino acids.

The subject invention utilizes “microbe-based compositions,” meaning a composition that comprises components that were produced as the result of the growth of microorganisms or other cell cultures. Thus, the microbe-based composition may comprise the microbes themselves and/or by-products of microbial growth. The microbes may be in a vegetative state, in spore or conidia form, in hyphae form, in any other form of propagule, or a mixture of these. The microbes may be planktonic or in a biofilm form, or a mixture of both. The by-products of growth may be, for example, metabolites, cell membrane components, proteins, and/or other cellular components. The microbes may be intact or lysed. In preferred embodiments, the microbes are present, with growth medium in which they were grown, in the microbe-based composition. The microbes may be present at, for example, a concentration of at least 1×10⁴, 1×10⁵, 1×10⁶, 1×10⁷, 1×10⁸, 1×10⁹, 1×10¹⁰, 1×10¹¹, 1×10¹² or 1×10¹³ or more CFU per gram or per ml of the composition.

The subject invention further provides “microbe-based products,” which are products that are to be applied in practice to achieve a desired result. The microbe-based product can be simply a microbe-based composition harvested from a microbe cultivation process. Alternatively, the microbe-based product may comprise further ingredients that have been added. These additional ingredients can include, for example, stabilizers, buffers, appropriate carriers, such as water, salt solutions, or any other appropriate carrier, added nutrients to support further microbial growth, non-nutrient growth enhancers and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

As used herein, the term “plant” includes, but is not limited to, any species of woody, ornamental or decorative, crop or cereal, fruit plant or vegetable plant, flower or tree, macroalga or microalga, phytoplankton and photosynthetic algae (e.g., green algae Chlamydomonas reinhardtii). “Plant” also includes a unicellular plant (e.g., microalga) and a plurality of plant cells that are largely differentiated into a colony (e.g., volvox) or a structure that is present at any stage of a plant's development. Such structures include, but are not limited to, a fruit, a seed, a shoot, a stem, a leaf, a root, a flower petal, etc. Plants can be standing alone, for example, in a garden, or can be one of many plants, for example, as part of an orchard, crop or pasture.

As used herein, “crop plants” refer to any species of plant or alga, grown for profit and/or for sustenance for humans, animals or aquatic organisms, or used by humans (e.g., textile, cosmetics, and/or drug production), or viewed by humans for pleasure (e.g., flowers or shrubs in landscaping or gardens) or any plant or alga, or a part thereof, used in industry, commerce or education. Crop plants can be plants that can be obtained by traditional breeding and optimization methods or by biotechnological and recombinant methods, or combinations of these methods, including the transgenic plants and the plant varieties.

All plants and plant parts can benefit from the subject invention. In this context, plants are understood as meaning all plants and plant populations such as desired and undesired wild plants or crop plants (including naturally occurring crop plants).

Plant tissue and/or plant parts are understood as meaning all aerial and subterranean parts and organs of the plants such as shoots, leaves, flowers, roots, needles, stalks, stems, fruits, seeds, tubers and rhizomes. The plant parts also include crop material and vegetative and generative propagation material, for example cuttings, tubers, rhizomes, slips and seeds.

As used herein “preventing” or “prevention” of a situation or occurrence means delaying, inhibiting, suppressing, forestalling, and/or minimizing the onset, extensiveness or progression of the situation or occurrence. Prevention can include, but does not require, indefinite, absolute or complete prevention, meaning it may still develop at a later time. Prevention can include reducing the severity of the onset of such a situation or occurrence, and/or stalling its development to a more severe or extensive situation or occurrence.

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “reduction” refers to a negative alteration, and the term “increase” refers to a positive alteration, wherein the negative or positive alteration is at least 0.25%, 0.5%, 1%, 5%, 10%, 15%, 20%, 25%, 30%, 35%, 40%, 45%, 50%, 55%, 60%, 70%, 75%, 80%, 85%, 90%, 95%, or 100%.

As used herein, “reference” refers to a standard or control condition.

As used herein, a “soil amendment” or a “soil conditioner” is any compound, material, or combination of compounds or materials that are added into soil to enhance the properties of the soil and/or rhizosphere. Soil amendments can include organic and inorganic matter, and can further include, for example, fertilizers, pesticides and/or herbicides. Nutrient-rich, well-draining soil is essential for the growth and health of plants, and thus, soil amendments can be used for enhancing the plant biomass by altering the nutrient and moisture content of soil. Soil amendments can also be used for improving many different qualities of soil, including but not limited to, soil structure (e.g., preventing compaction); improving the nutrient concentration and storage capabilities; improving water retention in dry soils; and improving drainage in waterlogged soils.

As used herein, “surfactant” refers to a compound that lowers the surface tension (or interfacial tension) between phases. Surfactants act as, e.g., detergents, wetting agents, emulsifiers, foaming agents, and dispersants. A “biosurfactant” is a surfactant produced by a living organism.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially” of the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof. All references cited herein are hereby incorporated by reference in their entirety.

### Compositions

In preferred embodiments, the subject invention provides adjuvant compositions comprising sophorolipids and/or novel derivatives thereof, which can serve as tank mix additives, formulating additives, or other adjuvant functions in agricultural and horticultural applications.

In a specific exemplary embodiment, the agricultural and horticultural applications include crop and non-crop pest control; however, reference to “pesticides” and “pesticidal activity” herein is not meant to limit the invention only to pesticides. In other words, the subject adjuvant compositions can be useful for any agricultural chemical applications including, for example, fertilizers, herbicides, plant growth regulators, soil amendments and irrigation additives, as well as enhancing the efficacy of agricultural chemicals for such applications.

In certain embodiments, the adjuvant composition comprises a surface active molecule. The surface active molecule can be a synthetic surfactant, a microbial- or plant-derived biosurfactant, and/or a surfactant produced using naturally-derived substrates.

In preferred embodiments, the surface active molecule is a microbial-derived biosurfactant. The biosurfactant can be applied in purified and/or crude form. Crude form biosurfactants can comprise, for example, biosurfactants and other products of cellular growth in the leftover fermentation medium resulting from cultivation of a biosurfactant-producing microbe. In some embodiments, the biosurfactant can be extracted, purified and/or subjected to chemical modification and/or derivatization.

Biosurfactants according to the subject methods can be selected from, for example, low molecular weight glycolipids (e.g., sophorolipids, cellobiose lipids, rhamnolipids, mannosylerythritol lipids and trehalose lipids), lipopeptides (e.g., surfactin, iturin, fengycin, arthrofactin and lichenysin), flavolipids, phospholipids (e.g., cardiolipins), fatty acid esters, and high molecular weight polymers such as lipoproteins, lipopolysaccharide-protein complexes, and polysaccharide-protein-fatty acid complexes.

In certain specific embodiments, the biosurfactant is a sophorolipid (SLP), such as, for example, a lactonic SLP, an acidic SLP, a salt-form SLP, or a derivative of any of these.

As used herein, the term “sophorolipid,” “sophorolipid molecule,” “SLP” or “SLP molecule” includes all forms, and isomers thereof, of SLP molecules, including, for example, acidic (linear) SLP (ASL) and lactonic SLP (LSL). Further included are mono-acetylated SLP, di-acetylated SLP, esterified SLP, amino-acid-SLP conjugate, metal-SLP conjugate, salt form SLP, SLP amino alcohols, SLP with carbonyl groups removed from the aliphatic chain, and/or any other derivatives of SLP molecules, including those that are and/or are not specifically referred to within this disclosure. The SLP molecule(s) can be in a pure form or crude form.

In certain embodiments, the SLP according to the subject invention are represented by General Formula (1) and/or General Formula (2), and are obtained as a collection of multiple structural homologues:

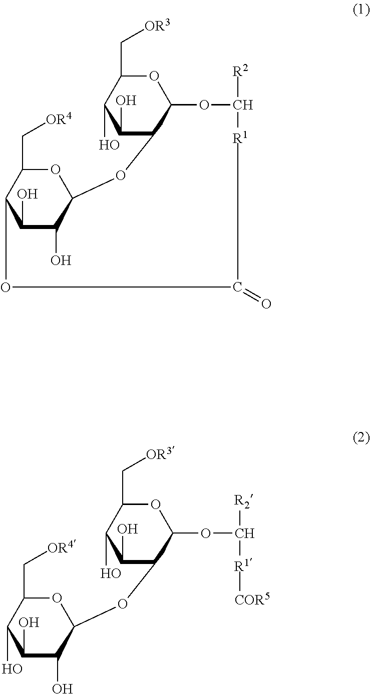

where R¹ and R^{1′} independently represent saturated hydrocarbon chains or single or multiple, in particular single, unsaturated hydrocarbon chains having 8 to 20, in particular 12 to 18 carbon atoms, more preferably 14 to 18 carbon atoms, which can be linear or branched and can comprise one or more hydroxy groups; R² and R^{2′} independently represent a hydrogen atom or a saturated alkyl functional group or a single or multiple, in particular single, unsaturated alkyl functional group having 1 to 9 carbon atoms, more preferably 1 to 4 carbon atoms, which can be linear or branched and can comprise one or more hydroxy groups; and R³, R^{3′}, R⁴ and R^{4′} independently represent a hydrogen atom or —COCH₃.

R⁵ is typically —OH; however, the subject invention also provides bio-derivatized linear-type SLP wherein R⁵ is, for example, an alcohol group. See General Formula (A).

Due to the structure and composition of SLP, these biosurfactants have excellent surface and interfacial tension reduction properties, as well as other beneficial biochemical properties, which can be useful in applications such as large scale industrial and agriculture uses, cosmetics, household products, health, medical and pharmaceutical fields, and oil and gas recovery.

In certain embodiments, the SLP molecules of the subject invention are linear SLP alcohols having the following General Formula (A):

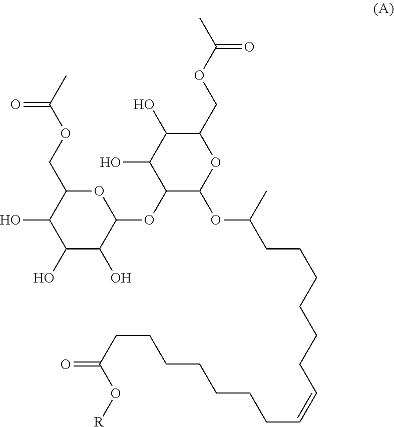

wherein R=an alcohol group such as, for example,

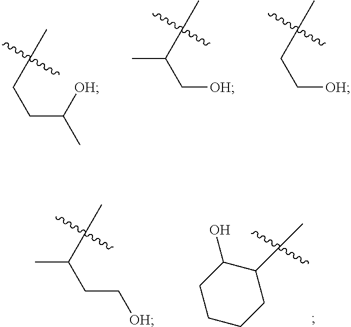

ethanol; methanol; heptanol; butanol; propanol; isopropanol; pentanol; hexanol; octanol; nonanol; or decanol.

In certain embodiments, the derivative linear SLP is produced by creating a bio-tailored fermentation medium and cultivating a sophorolipid-producing yeast in the fermentation medium to produce a yeast culture. The yeast culture comprises liquid broth, yeast cells, and a mixture of linear-type and lactonic SLP.

The bio-tailored fermentation medium comprises a source of fatty acids and/or triglycerides, and optionally, further comprises, or lacks, a particular component, wherein the presence or lack of the component alters the metabolic pathway through which sophorolipids are produced. The result of fermentation is thus altered from what is achieved through traditional fermentation parameters.

In certain embodiments, the bio-tailored fermentation medium comprises a bio-based component that alters the activity of the lactone esterase enzyme, which is responsible for catalyzing the intramolecular esterification (lactonization) of linear SLP to produce lactonic SLP. In some embodiments, the bio-based component is a mono-, di- or poly-alcohol, which can bind to and esterify the carboxyl group of a linear SLP fatty acid chain, thereby blocking intramolecular esterification of the sophorose moiety.

In certain embodiments, the use of an alcohol component in the bio-tailored fermentation medium eliminates the need for traditional carbohydrate sources, e.g., sugars such as glucose. This improves the sustainability, cost-effectiveness and efficiency of the production method through reduction in total raw materials. In some embodiments, a sugar can be included, although preferably sourced from a local supplier, e.g., within 100 miles of the fermentation facility.

The addition of an alcohol, such as, e.g., glycerol, to the bio-tailored fermentation medium shifts the traditional production of predominantly lactonic SLP to predominantly linear-type SLP at surprisingly and advantageously high ratios. For example, in certain embodiments, the yeast culture comprises at least 70%, at least 80% or at least 90% linear-type SLP with respect to the total amount of SLP produced. In certain embodiments, the use of an alcohol component also reduces the fermentation time from, e.g., 90-120 hours down to 70-80 hours, when compared with use of a traditional carbohydrate source.

Other examples of bio-based components for use in the bio-tailored fermentation medium include but are not limited to C2-C10 alkyl chain alcohols, including mono-alcohols, e.g., ethanol, methanol, propanol, butanol, isopropanol; diols, e.g., ethylene glycol, propylene glycol, butylene glycol, cyclohexane-1,2-diol; and polyols, e.g., glycerine, polyethylene glycol, polypropylene glycol, polytetrahydrofuran, castor oil, sorbitol, mannitol, xylitol, maltitol, maltitol syrup, lactitol, erythritol, and isomalt.

In certain embodiments, the method can further comprise collecting, extracting, isolating and/or purifying the SLP from the yeast culture. In some embodiments, the bio-derivatized linear SLP are separated from the lactonic SLP, while in other embodiments, the SLP mixture is left as a mixture.

In preferred embodiments, the sophorolipid-producing yeast is Starmerella bombicola, or another member of the Starmerella and/or Candida clades. For example, S. bombicola strain ATCC 22214 can be used according to the subject methods. GMO yeasts are not required to achieve the desired increased linear-type SLP ratio in the SLP mixture; however, the subject methods are not limited to non-GMO microorganisms.

In certain embodiments, in addition to the surprising increase in the ratio of linear-type SLP molecules and decrease in fermentation time, the subject methods also result in the production of novel bio-derivatized linear SLP molecules with surprisingly similar, or even improved, properties compared with conventionally-produced linear SLP, e.g., critical micelle concentration (CMC), surface tension reduction, interfacial tension reduction, wettability alteration, and foaming. Thus, with fewer material inputs, fewer chemical reactions outside of standard fermentation, and no requirement for the use of GMO organisms, the subject methods allow for the production of bio-based SLP products with comparable or improved properties to non-derivatized SLP products.

In certain embodiments, the adjuvant composition of the subject invention does not contain lactonic SLP. In certain embodiments, the composition comprises some lactonic SLP, e.g., 30% or less of the SLP is lactonic.

In certain preferred embodiments, the adjuvant composition comprises linear SLP, including linear forms subject to General Formula (A), and no lactonic SLP. The linear SLP can be further extracted or purified to remove impurities or residual materials from fermentation such as fatty acids or glucose. In certain embodiments, the composition contains no fatty acids.

SLP are typically produced by yeasts, such as Starmerella spp. yeasts and/or Candida spp. yeasts, e.g., Starmerella (Candida) bombicola, Candida apicola, Candida batistae, Candida floricola, Candida riodocensis, Candida stellate and/or Candida kuoi. SLP have environmental compatibility, high biodegradability, low toxicity, high selectivity and specific activity in a broad range of temperature, pH and salinity conditions.

In preferred embodiments, the sophorolipid of the subject composition has a micelle size less than 100 nm, less than 75 nm, less than 50 nm, and more preferably less than 25 nm. In certain embodiments, the micelle size is less than 10 nm, less than 8 nm, or less than 5 nm.

In certain embodiments, the adjuvant composition having small micelle size (e.g., less than 20 nm) or, more preferably, an ultra-small micelle size (e.g., less than 5 nm), is particularly advantageous over synthetic surfactants for transporting active agricultural chemicals through small pores and tight junctures in plant and pest tissue, and in soil.

The adjuvant compositions can be used as additives in formulations such as, for example, suspension concentrates, capsule suspensions, emulsifiable concentrates, water-soluble concentrates, oil dispersions, suspoemulsions, emulsions in water, water-dispersible granules or powders, alongside other added substances, such as, for example, dispersants, emulsifiers, thickeners, and defoamers, with an adjuvant content of 1% by weight to 99% by weight, 1.5% by weight to 60% by weight, or from 2.0% to 25% by weight. In certain preferred embodiments, the adjuvants are utilized as tank mix additives.

In some embodiments, the subject invention provides agricultural compositions comprising the adjuvant composition of the subject invention and one or more agricultural chemicals selected from, for example, a pesticide, herbicide, fertilizer, irrigation fluid, or plant growth regulators.

In certain embodiments, the active agricultural chemical is one or more of the following non-limiting examples, which are identified here by their common names are known and are described, for example, in the pesticide handbook (“The Pesticide Manual” 16th Ed., British Crop Protection Council 2012) or can be found on the Internet (e.g. http://www.alanwood.net/pesticides). The classification is based on the current IRAC Mode of Action Classification Scheme at the time of filing of this patent application.

Examples of fungicides according to the invention are: 1) Inhibitors of the ergosterol biosynthesis, for example, cyproconazole; difenoconazole; epoxiconazole; fenhexamid; fenpropidin; fenpropimorph; fenpyrazamine; fluquinconazole; flutriafol; imazalil; imazalil sulfate; ipconazole; metconazole; myclobutanil; paclobutrazol; prochloraz; propiconazole; prothioconazole; pyrisoxazole; spiroxamine; tebuconazole; tetraconazole; triadimenol; tridemorph; triticonazole; (1R,2S,5 S)-5-(4-chlorobenzyl)-2-(chloromethyl)-2-methyl-1-(1H-1,2,4-triazol-1-ylmethyl)cyclopentanol; (1S,2R,5R)-5-(4-chlorobenzyl)-2-(chloromethyl)-2-methyl-1-(1H 1, 2, 4-triazol-1-ylmethyl)cy clopentanol; (2R)-2-(1-chlorocyclopropyl)-4-[(1R)-2,2 dichlorocyclopropyl]-1-(1H-1,2,4-triazol-1-yl)butan-2-ol; (2R)-2-(1-chlorocyclopropyl)-4[(1S)-2,2-dichlorocyclopropyl]-1-(1H-1,2,4-triazol-1-yl)butan-2-ol; (2R)-2-[4-(4 chlorophenoxy)-2-(trifluoromethyl)phenyl]-1-(1H-1,2,4-triazol-1-yl)propan-2-ol; (2S)-2-(1 chlorocyclopropyl)-4-[(1R)-2,2-dichlorocyclopropyl]-1-(1H-1,2,4-triazol-1-yl)butan-2-ol; (2S)-2-(1-chloro-cyclopropyl)-4-[(1S)-2,2-dichlorocyclopropyl]-1-(1H-1,2,4-triazol-1-yl)butan-2-ol; (2S)-2-[4-(4-chlorophenoxy)-2-(trifluoromethyl)phenyl]-1-(1H-1,2,4-triazol-1-yl)propan-2-ol; (R)-[3-(4-chloro-2-fluorophenyl)-5-(2,4-difluorophenyl)-1,2-oxazol-4-yl](pyridin-3-yl)methanol; (S)-[3-(4-chloro-2-fluorophenyl)-5-(2,4-difluorophenyl)-1,2-oxazol-4-yl](pyridin-3-yl)methanol; [3-(4-chloro-2-fluorophenyl)-5-(2,4-difluorophenyl)-1,2-oxazol-4-yl](pyridin-3-yl)methanol; 1-({(2R,4S)-2-[2-chloro-4-(4-chlorophenoxy)phenyl]-4-methyl-1,3-dioxolan-2-yl}methyl)-1H-1,2,4-triazole; 1-({(2S,4S)-2-[2-chloro-4-(4-chlorophenoxy)phenyl]-4-methyl-,3-dioxolan-2-yl}methyl)-1H-1,2,4-triazole; 1-{[3-(2-chlorophenyl)-2-(2,4-difluorophenyl)oxiran-2-yl]methyl}-1H-1,2,4-triazol-5-yl thiocyanate; 1-{[rel(2R,3R)-3-(2-chlorophenyl)-2-(2,4-difluorophenyl)oxiran-2-yl]methyl}-1H-1,2,4-triazol-5-yl thiocyanate; I-{[rel(2R,3S)-3-(2-chlorophenyl)-2-(2,4-difluorophenyl)oxiran-2-yl]methyl}-1H-1,2,4-triazol-5-yl thiocyanate; 2-[(2R,4R,5R)-1-(2,4-dichlorophenyl)-5-hydroxy-2,6,6-trimethylheptan-4-yl]-2,4-dihydro-3H-1,2,4-triazole-3-thione; 2-[(2R,4R,5S)-1-(2,4-dichlorophenyl)-5-hydroxy-2,6,6-trimethylheptan-4-yl]-2,4-dihydro-3H-1,2,4-triazole-3-thione; 2-[(2R,4S,5R)-1-(2,4-dichlorophenyl)-5-hydroxy-2,6,6-trimethylheptan-4-yl]-2,4-dihydro-3H-1,2,4-triazole-3-thione; 2-[(2R,4S,5S)-1-(2,4-dichloro-phenyl)-5-hydroxy-2,6,6-trimethylheptan-4-yl]-2,4-dihydro-3H-1,2,4-triazole-3-thione; 2-[(2S,4R,5R)-1-(2,4-dichlorophenyl)-5-hydroxy-2,6,6-trimethylheptan-4-yl]-2,4-dihydro-3H-1,2,4-triazole-3-thione; 2-[(2S,4R,5S)-1-(2,4-dichlorophenyl)-5-hydroxy-2,6,6-trimethylheptan-4-yl]-2,4-dihydro-3H-1,2,4-triazole-3-thione; 2-[(2S,4S,5R)-1-(2,4-dichlorophenyl)-5-hydroxy-2,6,6-trimethylheptan-4-yl]-2,4-dihydro-3H-1,2,4-triazole-3-thione; 2-[(2S,4S,5S)-1-(2,4-dichlorophenyl)-5-hydroxy-2,6,6-trimethylheptan-4-yl]-2,4-dihydro-3H-1,2,4-triazole-3-thione; 2-[1-(2,4-dichlorophenyl)-5-hydroxy-2,6,6-trimethylheptan-4-yl]-2,4-dihydro-3H-1,2,4-triazole-3-thione; 2-[2-chloro-4-(2,4-dichlorophenoxy)phenyl]-1-(1H-1,2,4-triazol-1-yl)propan-2-ol; 2-[2-chloro-4-(4-chlorophenoxy)phenyl]-1-(1H-1,2,4-triazol-1-yl)butan-2-ol; 2-[4-(4-chlorophenoxy)-2-(trifluoromethyl)phenyl]-1-(1H-1,2,4-triazol-1-yl)butan-2-ol; 2-[4-(4-chlorophenoxy)-2-(trifluoromethyl)phenyl]-1-(1H-1,2,4-triazol-1-yl)pentan-2-ol; mefentrifluconazole; 2-{[3-(2-chlorophenyl)-2-(2,4-difluorophenyl)oxiran-2-yl]methyl}-2,4-dihydro-3H-1,2,4-triazole-3-thione; 2-{[rel(2R,3R)-3-(2-chlorophenyl)-2-(2,4-difluoro-phenyl)oxiran-2-yl]methyl}-2,4-dihydro-3H-1,2,4-triazole-3-thione; 2-{[rel(2R,3S)-3-(2-chlorophenyl)-2-(2,4-difluorophenyl)oxiran-2-yl]methyl}-2,4-dihydro-3H-1,2,4-triazole-3-thione; 5-(4-chlorobenzyl)-2-(chloromethyl)-2-methyl-1-(1H-1,2,4-triazol-1-ylmethyl)cyclopentanol; 5-(allylsulfanyl)-1-{[3-(2-chlorophenyl)-2-(2,4-difluorophenyl)oxiran-2-yl]methyl}-1H-1,2,4-triazole; 5-(allylsulfanyl)-1-{[rel(2R,3R)-3-(2-chlorophenyl)-2-(2,4-difluorophenyl)oxiran-2-yl]methyl}-1H-1,2,4-triazole; 5-(allylsulfanyl)-1-{[rel(2R,3S)-3-(2-chlorophenyl)-2-(2,4-difluorophenyl)oxiran-2-yl]methyl}-1H-1,2,4-triazole; N′-(2,5-dimethyl-4-{[3-(1,1,2,2-tetrafluoroethoxy)phenyl]sulfanyl}phenyl)-N-ethyl-N-methylimidoformamide; N′-(2,5-dimethyl-4-{[3-(2,2,2-trifluoroethoxy)phenyl]sulfanyl}phenyl)-N-ethyl-N-methylimidoformamide; N′-(2,5-dimethyl-4-{[3-(2,2,3,3-tetrafluoropropoxy) phenyl]sulfanyl}phenyl)-N-ethyl-N-methylimidoformamide; N′-(2,5-dimethyl-4-{[3-(pentafluoroethoxy)phenyl]sulfanyl}phenyl)-N-ethyl-N-methylimidoformamide; N′-(2,5-dimethyl-4-{3-[(1,1,2,2-tetrafluoroethyl)sulfanyl]-phenoxy}phenyl)-N-ethyl-N-methylimidoformamide; N′-(2,5-dimethyl-4-{3-[(2,2,2-trifluoro-ethyl)sulfanyl]phenoxy}phenyl)-N-ethyl-N-methylimidoformamide; N′-(2,5-dimethyl-4-{3-[(2,2,3,3-tetrafluoropropyl)sulfanyl]phenoxy}phenyl)-N-ethyl-N-methylimidoformamide; N′-(2,5-dimethyl-4-{3-[(pentafluoroethyl)sulfanyl]phenoxy}phenyl)-N-ethyl-N-methylimidoformamide; N′-(2,5-dimethyl-4-phenoxyphenyl)-N-ethyl-N-methylimidoformamide; N′-(4-{[3-(difluoromethoxy)phenyl]sulfanyl}-2,5-dimethylphenyl)-N-ethyl-N-methylimidoformamide; N′-(4-{3-[(difluoromethyl)sulfanyl]phenoxy}-2,5-dimethylphenyl)-N-ethyl-N-methylimidoformamide; N′-[5-bromo-6-(2,3-dihydro-1H-inden-2-yloxy)-2-methylpyridin-3-yl]-N-ethyl-N-methylimido-formamide; N′-{4-[(4,5-dichloro-1,3-thiazol-2-yl)oxy]-2,5-dimethylphenyl}-N-ethyl-N-methylimidoformamide; N′-{5-bromo-6-[(1R)-1-(3,5-difluorophenyl)ethoxy]-2-methylpyridin-3-yl}-N-ethyl-N-methylimidoformamide; N′-{5-bromo-6-[(1S)-1-(3,5-difluorophenyl)ethoxy]-2-methylpyridin-3-yl}-N-ethyl-N-methylimidoformamide; N′-{5-bromo-6-[(cis-4-isopropyl-cyclohexyl)oxy]-2-methylpyridin-3-yl}-N-ethyl-N-methylimidoformamide; N′-{5-bromo-6-[(trans-4-isopropylcyclohexyl)oxy]-2-methylpyridin-3-yl}-N-ethyl-N-methylimidoformamide; N′-{5-bromo-6-[1-(3,5-difluorophenyl)ethoxy]-2-methylpyridin-3-yl}-N-ethyl-N-methylimido-formamide; ipfentrifluconazole; 2-[4-(4-chlorophenoxy)-2-(trifluoromethyl)phenyl]-1-(1H-1,2,4-triazol-1-yl)propan-2-ol; 2-[6-(4-bromophenoxy)-2-(trifluoromethyl)-3-pyridyl]-1-(1,2,4-triazol-1-yl)propan-2-ol; 2-[6-(4-chlorophenoxy)-2-(trifluoromethyl)-3-pyridyl]-1-(1,2,4-triazol-1-yl)propan-2-ol; 3-[2-(1-chlorocyclopropyl)-3-(3-chloro-2-fluoro-phenyl)-2-hydroxy-propyl]imidazole-4-carbonitrile; 4-[[6-[rac-(2R)-2-(2,4-difluorophenyl)-1,1-difluoro-2-hydroxy-3-(5-thioxo-4H-1,2,4-triazol-1-yl)propyl]-3-pyridyl]oxy]benzonitrile; N-isopropyl-N′-[5-methoxy-2-methyl-4-(2,2,2-trifluoro-1-hydroxy-1-phenylethyl)phenyl]-N-methylimidoformamide; N′-{5-bromo-2-methyl-6-[(1-propoxypropan-2-yl)oxy]pyridin-3-yl}-N-ethyl-N-methylimido-formamide; hexaconazole; penconazole; and fenbuconazole;
2) Inhibitors of the respiratory chain at complex I or II, for example, benzovindiflupyr; bixafen; boscalid; carboxin; fluopyram; flutolanil; fluxapyroxad; furametpyr; Isofetamid; isopyrazam (anti-epimeric enantiomer 1R,4S,9S); isopyrazam (anti-epimeric enantiomer 1S,4R,9R); isopyrazam (anti-epimeric racemate 1RS,4SR,9SR); isopyrazam (mixture of syn-epimeric racemate 1RS,4SR,9RS and anti-epimeric racemate 1RS,4SR,9SR); isopyrazam (syn-epimeric enantiomer 1R,4S,9R); isopyrazam (syn-epimeric enantiomer 1S,4R,9S); isopyrazam (syn-epimeric racemate 1RS,4SR,9RS); penflufen; penthiopyrad; pydiflumetofen; Pyraziflumid; sedaxane; 1,3-dimethyl-N-(1,1,3-trimethyl-2,3-dihydro-1H-inden-4-yl)-1H-pyrazole-4-carboxamide; 1,3-dimethyl-N-[(3R)-1,1,3-trimethyl-2,3-dihydro-1H-inden-4-yl]-1H-pyrazole-4-carboxamide; 1,3-dimethyl-N-[(3S)-1,1,3-trimethyl-2,3-dihydro-1H-inden-4-yl]-1H-pyrazole-4-carboxamide; 1-methyl-3-(trifluoromethyl)-N-[2′-(trifluoromethyl)biphenyl-2-yl]-1H-pyrazole-4-carboxamide; 2-fluoro-6-(trifluoromethyl)-N-(1,1,3-trimethyl-2,3-dihydro-1H-inden-4-yl)benzamide; 3-(difluoromethyl)-1-methyl-N-(1,1,3-trimethyl-2,3-dihydro-1H-inden-4-yl)-1H-pyrazole-4-carboxamide; inpyrfluxam; 3-(difluoromethyl)-1-methyl-N-[(3S)-I,I,3-trimethyl-2,3-dihydro-1H-inden-4-yl]-1H-pyrazole-4-carboxamide; fluindapyr; 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide; 5,8-difluoro-N-[2-(2-fluoro-4-{[4-(trifluoromethyl)-pyridin-2-yl]oxy}phenyl)ethyl]quinazolin-4-amine; N-(2-cyclopentyl-5-fluorobenzyl)-N-cyclopropyl-3-(difluoromethyl)-5-fluoro-1-methyl-1H-pyrazole-4-carboxamide; N-(2-tert-butyl-5-methylbenzyl)-N-cyclopropyl-3-(difluoromethyl)-5-fluoro-1-methyl-1H-pyrazole-4-carboxamide; N-(2-tert-butylbenzyl)-N-cyclopropyl-3-(difluoromethyl)-5-fluoro-1-methyl-1H-pyrazole-4-carboxamide; N-(5-chloro-2-ethylbenzyl)-N-cyclopropyl-3-(difluoromethyl)-5-fluoro-1-methyl-1H-pyrazole-4-carboxamide; isoflucypram; N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide; N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide; N-[1-(2,4-dichlorophenyl)-1-methoxypropan-2-yl]-3-(difluoromethyl)-1-methyl-1H-pyrazole-4-carboxamide; N-[2-chloro-6-(trifluoromethyl)benzyl]-N-cyclopropyl-3-(difluoromethyl)-5-fluoro-1-methyl-1H-pyrazole-4-carboxamide; N-[3-chloro-2-fluoro-6-(trifluoromethyl)benzyl]-N-cyclopropyl-3-(difluoromethyl)-5-fluoro-1-methyl-1H-pyrazole-4-carboxamide; N-[5-chloro-2-(trifluoromethyl)benzyl]-N-cyclopropyl-3-(difluoromethyl)-5-fluoro-1-methyl-1H-pyrazole-4-carboxamide; N-cyclopropyl-3-(difluoromethyl)-5-fluoro-1-methyl-N-[5-methyl-2-(trifluoromethyl)benzyl]-1H-pyrazole-4-carboxamide; N-cyclopropyl-3-(difluoromethyl)-5-fluoro-N-(2-fluoro-6-isopropylbenzyl)-1-methyl-1H-pyrazole-4-carboxamide; N-cyclopropyl-3-(difluoromethyl)-5-fluoro-N-(2-isopropyl-5-methylbenzyl)-1-methyl-1H-pyrazole-4-carboxamide; N-cyclopropyl-3-(difluoromethyl)-5-fluoro-N-(2-isopropylbenzyl)-1-methyl-1H-pyrazole-4-carbothioamide; N-cyclopropyl-3-(difluoromethyl)-5-fluoro-N-(2-isopropylbenzyl)-1-methyl-1H-pyrazole-4-carboxamide; N-cyclopropyl-3-(difluoromethyl)-5-fluoro-N-(5-fluoro-2-isopropylbenzyl)-1-methyl-1H-pyrazole-4-carboxamide; N-cyclopropyl-3-(difluoromethyl)-N-(2-ethyl-4,5-dimethylbenzyl)-5-fluoro-1-methyl-1H-pyrazole-4-carboxamide; N-cyclopropyl-3-(difluoromethyl)-N-(2-ethyl-5-fluorobenzyl)-5-fluoro-1-methyl-1H-pyrazole-4-carboxamide; N-cyclopropyl-3-(difluoromethyl)-N-(2-ethyl-5-methylbenzyl)-5-fluoro-1-methyl-1H-pyrazole-4-carboxamide; N-cyclopropyl-N-(2-cyclopropyl-5-fluorobenzyl)-3-(difluoromethyl)-5-fluoro-1-methyl-1H-pyrazole-4-carboxamide; N-cyclopropyl-N-(2-cyclopropyl-5-methylbenzyl)-3-(difluoromethyl)-5-fluoro-1-methyl-1H-pyrazole-4-carboxamide; N-cyclopropyl-N-(2-cyclopropylbenzyl)-3-(difluoromethyl)-5-fluoro-1-methyl-1H-pyrazole-4-carboxamide; pyrapropoyne; N-[rac-(1S,2S)-2-(2,4-dichlorophenyl)cyclobutyl]-2-(trifluoromethyl)-nicotinamide; and N-[(1S,2S)-2-(2,4-dichlorophenyl)cyclobutyl]-2-(trifluoromethyl)nicotinamide;
3) Inhibitors of the respiratory chain at complex III, for example, ametoctradin; amisulbrom; azoxystrobin; coumethoxystrobin; coumoxystrobin; cyazofamid; dimoxystrobin; enoxastrobin; famoxadone; fenamidone; flufenoxystrobin; fluoxastrobin; kresoxim-methyl; metominostrobin; orysastrobin; picoxystrobin; pyraclostrobin; pyrametostrobin; pyraoxystrobin; trifloxystrobin; (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide; (2E,3Z)-5-{[1-(4-chlorophenyl)-1H-pyrazol-3-yl]oxy}-2-(methoxyimino)-N,3-dimethylpent-3-enamide; (2R)-2-{2-[(2,5-dimethylphenoxy)methyl]phenyl}-2-methoxy-N-methylacetamide; (2S)-2-{2-[(2,5-dimethylphenoxy)methyl]phenyl}-2-methoxy-N-methylacetamide; fenpicoxamid; mandestrobin; N-(3-ethyl-3,5,5-trimethylcyclohexyl)-3-formamido-2-hydroxybenzamide; (2E,3Z)-5-{[I-(4-chloro-2-fhiorophenyl)-1H-pyrazol-3-yl]oxy}-2-(methoxyimino)-N,3-dimethylpent-3-enamide; methyl{5-[3-(2,4-dimethylphenyl)-1H-pyrazol-1-yl]-2-methylbenzyl}carbamate; metyltetraprole; and florylpicoxamid
4) Inhibitors of the mitosis and cell division, for example, carbendazim; diethofencarb; ethaboxam; fluopicolide; pencycuron; thiabendazole; thiophanate-methyl; zoxamide; pyridachlometyl; 3-chloro-5-(4-chlorophenyl)-4-(2,6-difluorophenyl)-6-methylpyridazine; 3-chloro-5-(6-chloropyridin-3-yl)-6-methyl-4-(2,4,6-trifhiorophenyl)pyridazine; 4-(2-bromo-4-fhiorophenyl)-N-(2,6-difluorophenyl)-1,3-dimethyl-1H-pyrazol-5-amine; 4-(2-bromo-4-fhrorophenyl)-N-(2-bromo-6-fluorophenyl)-1,3-dimethyl-1H-pyrazol-5-amine; 4-(2-bromo-4-fhiorophenyl)-N-(2-bromophenyl)-1,3-dimethyl-1H-pyrazol-5-amine; 4-(2-bromo-4-fhrorophenyl)-N-(2-chloro-6-fluorophenyl)-1,3-dimethyl-1H-pyrazol-5-amine; 4-(2-bromo-4-fhrorophenyl)-N-(2-chlorophenyl)-1,3-dimethyl-1H-pyrazol-5-amine; 4-(2-bromo-4-fhrorophenyl)-N-(2-fluorophenyl)-1,3-dimethyl-1H-pyrazol-5-amine; 4-(2-chloro-4-fhiorophenyl)-N-(2,6-difluorophenyl)-1,3-dimethyl-1H-pyrazol-5-amine; 4-(2-chloro-4-fhiorophenyl)-N-(2-chloro-6-fluorophenyl)-1,3-dimethyl-1H-pyrazol-5-amine; 4-(2-chloro-4-fluorophenyl)-N-(2-chlorophenyl)-1,3-dimethyl-1H-pyrazol-5-amine; 4-(2-chloro-4-fhiorophenyl)-N-(2-fluorophenyl)-1,3-dimethyl-1H-pyrazol-5-amine; 4-(4-chlorophenyl)-5-(2,6-difluorophenyl)-3,6-dimethylpyridazine; N-(2-bromo-6-fluorophenyl)-4-(2-chloro-4-fluorophenyl)-1,3-dimethyl-1H-pyrazol-5-amine; N-(2-bromophenyl)-4-(2-chloro-4-fhiorophenyl)-1,3-dimethyl-1H-pyrazol-5-amine; N-(4-chloro-2,6-difluorophenyl)-4-(2-chloro-4-fluorophenyl)-1,3-dimethyl-1H-pyrazol-5-amine; and fluopimomide;
5) Compounds capable of multisite action, for example, bordeaux mixture; captafol; captan; chlorothalonil; copper hydroxide; copper naphthenate; copper oxide; copper oxychloride; copper(2+) sulfate; dithianon; dodine; folpet; mancozeb; maneb; metiram; metiram zinc; oxine-copper; propineb; sulfur and sulfur preparations including calcium polysulfide; thiram; zineb; ziram; and 6-ethyl-5,7-dioxo-6,7-dihydro-5H-pyrrolo[3′,4′:5,6][1,4]dithiino[2,3-c][1,2]thiazole-3-carbonitrile;
6) Compounds capable of inducing a host defense, for example, acibenzolar-S-methyl;
isotianil; probenazole; and tiadinil;
7) Inhibitors of amino acid and/or protein biosynthesis, for example, cyprodinil; kasugamycin; kasugamycin hydrochloride hydrate; oxytetracycline; pyrimethanil; and 3-(5-fluoro-3,3,4,4-tetramethyl-3,4-dihydroisoquinolin-1-yl)quinoline;
8) Inhibitors of ATP production, for example, silthiofam;
9) Inhibitors of cell wall synthesis, for example, benthiavalicarb; dimethomorph; flumorph; iprovalicarb; mandipropamid; pyrimorph; valifenalate; (2E)-3-(4-tert-butylphenyl)-3-(2-chloropyridin-4-yl)-1-(morpholin-4-yl)prop-2-en-1-one; and (2Z)-3-(4-tert-butylphenyl)-3-(2-chloropyridin-4-yl)-1-(morpholin-4-yl)prop-2-en-1-one;
10) Inhibitors of lipid and membrane synthesis, for example, propamocarb; propamocarb hydrochloride; and tolclofos-methyl;
11) Inhibitors of melanin biosynthesis, for example, tricyclazole; and tolprocarb;
12) Inhibitors of nucleic acid synthesis, for example, benalaxyl; benalaxyl-M (kiralaxyl); metalaxyl; and metalaxyl-M (mefenoxam);
13) Inhibitors of signal transduction, for example, fludioxonil; iprodione; procymidone; proquinazid; quinoxyfen; and vinclozolin;
14) Compounds capable of acting as an uncoupler, for example, fluazinam; and meptyldinocap;
15) Further fungicides selected from the group consisting of abscisic acid; benthiazole; bethoxazin; capsimycin; carvone; chinomethionat; cufraneb; cyflufenamid; cymoxanil; cyprosulfamide; flutianil; fosetyl-aluminium; fosetyl-calcium; fosetyl-sodium; methyl isothiocyanate; metrafenone; mildiomycin; natamycin; nickel dimethyldithiocarbamate; nitrothal-isopropyl; oxamocarb; oxathiapiprolin; oxyfenthiin; pentachlorophenol and salts; phosphorous acid and its salts; propamocarb-fosetylate; pyriofenone (chlazafenone); tebufloquin; tecloftalam; tolnifanide; 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethenone; 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethenone; 2-(6-benzylpyridin-2-yl)quinazoline; dipymetitrone; 2-[3,5-bis(difhioromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethenone; 2-[3,5-bis(difhroromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethenone; 2-[3,5-bis(difhroromethyl)-1H-pyrazol-1-yl]-1-[4-(4-{5-[2-fluoro-6-(prop-2-yn-1-yloxy)-phenyl]-4,5-dihydro-1,2-oxazol-3-yl}-1,3-thiazol-2-yl)piperidin-1-yl]ethenone; 2-[6-(3-fluoro-4-methoxyphenyl)-5-methylpyridin-2-yl]quinazoline; 2-{(5R)-3-[2-(1-{[3,5-bis(difluoro-methyl)-1H-pyrazol-1-yl]acetyl}piperidin-4-yl)-1,3-thiazol-4-yl]-4,5-dihydro-1,2-oxazol-5-yl}-3-chlorophenyl methanesulfonate; 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate; ipflufenoquin; 2-{2-fhioro-6-[(8-fhroro-2-methylquinolin-3-yl)oxy]phenyl}propan-2-ol; fluoxapiprolin; 2-{3-[2-(1-{[3,5-bis(difhroromethyl)-1H-pyrazol-1-yl]acetyl}piperidin-4-yl)-1,3-thiazol-4-yl]-4,5-dihydro-1,2-oxazol-5-yl}phenyl methanesulfonate; 2-phenylphenol and salts; 3-(4,4,5-trifhroro-3,3-dimethyl-3,4-dihydroisoquinolin-1-yl)quinoline; quinofumelin; 4-amino-5-fluoropyrimidin-2-ol (tautomeric form: 4-amino-5-fluoropyrimidin-2(1H)-one); 4-oxo-4-[(2-phenylethyl)amino]butanoic acid; 5-amino-1,3,4-thiadiazole-2-thiol; 5-chloro-N′-phenyl-N′-(prop-2-yn-1-yl)thiophene-2-sulfonohydrazide; 5-fluoro-2-[(4-fluorobenzyl)oxy]-pyrimidin-4-amine; 5-fluoro-2-[(4-methylbenzyl)oxy]pyrimidin-4-amine; 9-fluoro-2,2-dimethyl-5-(quinolin-3-yl)-2,3-dihydro-1,4-benzoxazepine; but-3-yn-1-yl{6-[({[(Z)-(1-methyl-1H-tetrazol-5-yl)(phenyl)methylene]amino}oxy)methyl]pyridin-2-yl}carbamate; ethyl (2Z)-3-amino-2-cyano-3-phenylacrylate; phenazine-1-carboxylic acid; propyl 3,4,5-trihydroxybenzoate; quinolin-8-ol; quinolin-8-ol sulfate (2:1); tertbutyl {6-[({[(1-methyl-1H-tetrazol-5-yl)(phenyl)methylene]amino}oxy)methyl]pyridin-2-yl}carbamate; 5-fluoro-4-imino-3-methyl-1-[(4-methylphenyl)sulfonyl]-3,4-dihydropyrimidin-2(1H)-one; aminopyrifen; (N′-[2-chloro-4-(2-fluorophenoxy)-5-methylphenyl]-N-ethyl-N-methylimido-formamide); (N′-(2-chloro-5-methyl-4-phenoxyphenyl)-N-ethyl-N-methylimidoformamide); (2-{2-[(7,8-difluoro-2-methylquinolin-3-yl)oxyl-6-fluorophenyl}propan-2-ol); (5-bromo-1-(5,6-dimethylpyridin-3-yl)-3,3-dimethyl-3,4-dihydroisoquinoline); (3-(4,4-difluoro-5,5-dimethyl-4,5-dihydrothieno[2,3-c]pyridin-7-yl)quinoline); (1-(4,5-dimethyl-1H-benzimidazol-1-yl)-4,4-difluoro-3,3-dimethyl-3,4-dihydroisoquinoline); 8-fluoro-3-(5-fluoro-3,3-dimethyl-3,4-dihydroisoquinolin-1-yl)quinolone; 8-fluoro-3-(5-fluoro-3,3,4,4-tetramethyl-3,4-dihydroisoquinolin-1-yl)quinolone; 3-(4,4-difluoro-3,3-dimethyl-3,4-dihydroisoquinolin-1-yl)-8-fluoroquinoline; (N-methyl-N-phenyl-4-[5-(trifluoromethyl)-1,2,4-oxadiazol-3-yl]benzamide); methyl{4-[5-(trifluoromethyl)-1,2,4-oxadiazol-3-yl]phenyl}carbamate; (N-{4-[5-(trifluoromethyl)-1,2,4-oxadiazol-3-yl]benzyl}cyclopropanecarboxamide); N-methyl-4-(5-(trifluoromethyl)-1,2,4-oxadiazol-3-yl]benzamide; N-[(E)-methoxyimino-methyl]-4-[5-(trifluoromethyl)-1,2,4-oxadiazol-3-yl]benzamide; N-[(Z) methoxyiminomethyl]-4-[5-(trifluoromethyl)-1,2,4-oxadiazol-3-yl]benzamide; N-[4-[5(trifluoromethyl)-1,2,4-oxadiazol-3-yl]phenyl]cyclopropanecarboxamide; N-(2 fluorophenyl)-4-[5-(trifluoromethyl)-1,2,4-oxadiazol-3-yl]benzamide; 2,2-difluoro-N-methyl-2-[4-[5-(trifluoromethyl)-1,2,4-oxadiazol-3-yl]phenyl]acetamide; N-allyl-N-[[4-[5-(trifluoromethyl)-1,2,4-oxadiazol-3-yl)phenyl]methyl]acetamide; N-[(E)-N-methoxy-C-methyl-carbonimidoyl]-4-(5-(trifluoro-methyl)-1,2,4-oxadiazol-3-yl]benzamide; N—[(Z)—N-methoxy-C-methyl-carbonimidoyl]-4-[5-(trifluoromethyl)-1,2,4-oxadiazol-3-yl]benzamide; N-allyl-N-[[4-[5-(trifluoromethyl)-1,2,4-oxadiazol-3-yl]phenyl]methyl]propenamide; 4,4-dimethyl-1-[[4-[5-(trifluoromethyl)-1,2,4-oxadiazol-3-yl]phenyl]methyl]pyrrolidin-2-one; N-methyl-4-[5-(trifluoromethyl)-1,2,4-oxadiazol-3-yl]benzenecarbothioamide; 5-methyl-1-[[4-[5-(trifluoromethyl)-1,2,4-oxadiazol-3-yl]phenyl]methyl]pyrrolidin-2-one; N-((2,3-difluoro-4-[5-(trifluoromethyl)-1,2,4-oxadiazol-3-yl]phenyl]methyl]-3,3,3-trifluoro-propanamide; 1-methoxy-1-methyl-3-[[4-[5-(trifluoro-methyl}-1,2,4-oxadiazol-3-yl]phenyl]methyl]urea; 1,1-diethyl-3-[[4-[5-(trifluoromethyl}-1,2,4-oxadiazol-3-yl]phenyl]methyl]urea; N-[[4-[5-(trifluoromethyl)-1,2,4-oxadiazol-3-yl]phen-yl]methyl]propenamide; N-methoxy-N-[[4-[5-(trifluoromethyl)-1,2,4-oxadiazol-3-yl]phenyl]-methyl]cyclopropanecarboxamide; 1-methoxy-3-methyl-1-[[4-[5-(trifluoromethyl)-1,2,4-oxadiazol-3-yl]phenyl]methyl]urea; N-methoxy-N-[[4-[5-(trifluoromethyl)-1,2,4-oxadiazol-3-yl]phenyl]methyl)cyclopropanecarboxamide; N,2-dimethoxy-N-[[4-[5-(trifluoromethyl}-1,2,4-oxadiazol-3-yl]phenyl]methyl]propenamide; N-ethyl-2-methyl-N-[[4-[5-(trifluoromethyl)-1,2,4-oxadiazol-3-yl)phenyl]methyl]propenamide; 1-methoxy-3-methyl-1-[[4-[5-(trifluoro-methyl)-1,2,4 oxadiazol-3-yl]phenyl]methyl]urea; 1,3-dimethoxy-1-[[4-[5-(trifluoromethyl)-1,2,4 oxadiazol-3-yl]phenyl]methyl]urea; 3-ethyl-1-methoxy-1-[[4-[5-(trifluoromethyl)-1,2,4 oxadiazol-3-yl]phenyl]methyl]urea; l-[[4-[5-(trifluoromethyl)-1,2,4-oxadiazol-3-yl]phenyl]methyl]piperidin-2-one; 4,4-dimethyl-2-[[4-[5-(trifluoromethyl)-1,2,4-oxadiazol-3 yl]phenyl]-methyl]isooxazolidin-3-one; 5,5-dimethyl-2-[[4-[5-(trifluoromethyl)-1,2,4 oxadiazol-3-yl]phenyl]methyl]isoxazolidin-3-one; 3,3-dimethyl-1-[[4-[5-(trifluoromethyl) 1.2.4-oxadiazol-3-yl]phenyl]methyllpiperidin-2-one; 1-[[3-fluoro-4-(5-(trifluoromethyl)1.2.4-oxadiazol-3-yl]-phenyl]methyl]azepan-2-one; 4,4-dimethyl-2-[[4-(5-(trifluoromethyl)1.2.4-oxadiazol-3-yl]-phenyl]methyl]isoxazolidin-3-one; 5,5-dimethyl-2-[[4-[5(trifluoromethyl)-1,2,4-oxadiazol-3-yl]phenyl]methyl]isoxazolidin-3-one; ethyl 1-{4-[5 (trifluoromethyl)-1,2,4-oxadiazol-3-yl]benzyl}-1H-pyrazole-4-carboxylate; N,N-dimethyl-1{4-[5-(trifluoromethyl)-1,2,4-oxadiazol-3-yl]benzyl}-1H-1,2,4-triazol-3-amine; N-{2,3 difluoro-4-[5-(trifluoromethyl)-1,2,4-oxadiazol-3-yl]benzyl}butanamide; N-(1 methylcyclopropyl)-4-[5-(trifluoromethyl)-1,2,4-oxadiazol-3-yl]benzamide; N-(2,4 difluorophenyl)-4-[5-(trifluoromethyl)-1,2,4-oxadiazol-3-yl]benzamide; 1-(5,6 dimethylpyridin-3-yl)-4,4-difluoro-3,3-dimethyl-3,4-dihydroisoquinoline; 1-(6(difluoromethyl)-5-methyl-pyridin-3-yl)-4,4-difluoro-3,3-dimethyl-3,4-dihydro-isoquinoline; 1-(5-(fluoromethyl)-6-methyl-pyridin-3-yl)-4,4-difluoro-3,3-dimethyl-3,4-dihydroisoquinoline; 1-(6-(difluoromethyl)-5-methoxy-pyridin-3-yl)-4,4-difluoro-3,3-dimethyl-3,4-dihydroisoquinoline; 4-[5-(trifluoromethyl)-1,2,4-oxadiazol-3-yl]phenyl dimethyl-carbamate; N-{4-[5-(trifluoromethyl)-1,2,4-oxadiazol-3-yl]phenyl}propenamide; 3-[2-(1-{[5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methane sulfonate; 9-fluoro-3-[2-(1-{[5-methyl-3-(trifluoromethyl)-1H-pyrazol-1-yl]acetyl}piperidin-4-yl)-1,3-thiazol-4-yl]-1,5-dihydro-2, 4-benzodioxepin-6-yl methanesulfonate; 3-[2-(1-{[3,5-bis(difluoromethyl)-1H-pyrazol-1-yl]acetyl}piperidin-4-yl)-1.3-thiazol-4-yl]-1,5-dihydro-2,4-benzodioxepin-6-yl methanesulfonate, (15.122) 3-[2-(1-{[3,5-bis(difluoromethyl)-1H-pyrazol-1-yl]acetyl}piperidin-4-yl)-1,3-thiazol-4-yl]-9-fluoro-1,5-dihydro-2.4-benzodioxepin-6-yl methane sulfonate; 1-(6,7-dimethylpyrazolo[1,5-a]pyridin-3-yl)-4,4-difluoro-3,3-dimethyl-3,4-dihydroisoquinoline; 8-fluoro-N-(4,4,4-trifluoro-2-methyl-1-phenylbutan-2-yl)quinoline-3-carboxamide; 8-fluoro-N-[(2S)-4,4,4-trifluoro-2-methyl-1-phenylbutan-2-yl]quinoline-3-carboxamide; N-(2,4-dimethyl-1-phenylpentan-2-yl)-8-fluoroquinoline-3-carboxamide; and N-[(2S)-2,4-dimethyl-1-phenylpentan-2-yl]-8-fluoroquinoline-3-carboxamide.

Examples of insecticides according to the invention include but are not limited to: (1) Acetylcholinesterase(AChE)-inhibitors, e.g., Carbamates Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, XMC and Xylylcarb, and/or organophosphates, e.g., Acephat, Azamethiphos, Azinphos-ethyl, Azinphos-methyl, Cadusafos, Chlorethoxyfos, Chlorfenvinphos, Chlormephos, Chlorpyrifos-methyl, Coumaphos, Cyanophos, Demeton-S-methyl, Diazinon, Dichlorvos/DDVP, Dicrotophos, Dimethoat, Dimethylvinphos, Disulfoton, EPN, Ethion, Ethoprophos, Famphur, Fenamiphos, Fenitrothion, Fenthion, Fosthiazat, Heptenophos, Imicyafos, Isofenphos, Isopropyl-O-(methoxyaminothio-phosphoryl)salicylat, Isoxathion, Malathion, Mecarbam, Methamidophos, Methidathion, Mevinphos, Monocrotophos, Naled, Omethoate, Oxydemeton-methyl, Parathion-methyl, Phenthoat, Phorat, Phosalon, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Triclorfon and Vamidothion;
(2) GABA-gated chloride channel antagonists, e.g., Cyclodien-organochlorines, such as Chlordan and/or Endosulfan, and/or Phenylpyrazoles (Fiprole), such as Ethiprol and Fipronil;
(3) Sodium channel modulators/voltage-dependent sodium channel blockers, for example pyrethroids, e.g. Acrinathrin, Allethrin, d-cis-trans Allethrin, d-trans Allethrin, Bifenthrin, Bioallethrin, Bioallethrin S-cyclopentenyl isomer, Bioresmethrin, Cycloprothrin, Cyfluthrin, beta-Cyfluthrin, Cyhalothrin, lambda-Cyhalothrin, gamma-Cyhalothrin, Cypermethrin, alpha-Cypermethrin, beta-Cypermethrin, theta-Cypermethrin, zeta-Cypermethrin, Cyphenothrin [(1R)-trans isomers], Deltamethrin, Empenthrin [(EZ)-(IR) isomers), Esfenvalerate, Etofenprox, Fenpropathrin, Fenvalerate, Flucythrinate, Flumethrin, tau-Fluvalinate, Halfenprox, Imiprothrin, Kadethrin, Momfluorothrin, Permethrin, Phenothrin [(IR)-trans isomer), Prallethrin, Pyrethrine (pyrethrum), Resmethrin, Silafluofen, Tefluthrin, Tetramethrin, Tetramethrin [(1R) isomers)], Tralomethrin and Transfluthrin, or DDT, or Methoxychlor;
(4) Nicotinic acetylcholine receptor (nAChR) competitive activators, e.g., Neonicotinoids, such as Acetamiprid, Clothianidin, Dinotefuran, Imidacloprid, Nitenpyram, Thiacloprid and Thiamethoxam, or Nicotin, or Sulfoximines, such as Sulfoxaflor, or Butenolides, such as Flupyradifurone, or Mesoionics, such as Triflumezopyrim;
(5) Nicotinic acetylcholine receptor (nAChR) allosteric activators, e.g., Spinosynes, such as Spinetoram and Spinosad;
(6) Allosteric modulators of the glutamate-dependent chloride channel (GluCl), e.g., Avermectines/Milbemycines, such as Abamectin, Emamectin-benzoate, Lepimectin and Milbemectin;
(7) Juvenile hormone mimetics, e.g., Juvenile hormone-analogs selected from Hydropren, Kinopren and Methopren, or Fenoxycarb, or Pyriproxyfen;
(8) Various non-specific (multi-site) inhibitors, e.g., Alkylhalogenides, such as Methylbromide and other Alkylhalogenides, or Chloropicrin, or Sulfurylfluorid, or Borax, or Tartar emetic, or Methylisocyanate generators, such as Diazomet and Metam;
(9) TRPV channel modulators of chordotonal organs, e.g., Pymetrozin and Pyrifluquinazon;
(10) Mite growth inhibitors, e.g., Clofentezin, Hexythiazox, Diflovidazin and Etoxazol;
(11) Microbial disruptors of the insect intestinal membrane, e.g., Bacillus thuringiensis Subspezies israelensis, Bacillus sphaericus, Bacillus thuringiensis Subspezies aizawai, Bacillus thuringiensis Subspezies kurstaki, Bacillus thuringiensis subspecies tenebrionis and B.t.-plant proteins such as Cry1Ab, Cry1Ac, Cry1Fa, Cry 1A.105, Cry2Ab, VIP3A, mCry3A, Cry3Ab, Cry3Bb and Cry34Abl/35Abl;
(12) Mitochondrial ATP synthase inhibitors, e.g., ATP-disruptors, such as Diafenthiuron, or Organo-tin-compounds, such as Azocyclotin, Cyhexatin and Fenbutatin-oxid, or Propargit, or Tetradifon;
(13) Decouplers of oxidative phosphorylation by disturbance of the proton gradient, e.g., Chlorfenapyr, DNOC and Sulfluramid;
(14) Nicotinic acetylcholine receptor channel blockers, e.g., Bensultap, Cartap-hydrochlorid, Thiocyclam and Thiosultap-Sodium;
(15) Inhibitors of chitin biosynthesis, Typ 0, e.g., Bistrifluron, Chlorfluazuron, Diflubenzuron, Flucycloxuron, Flufenoxuron, Hexaflumuron, Lufenuron, Novaluron, Noviflumuron, Teflubenzuron and Triflumuron;
(16) Inhibitors of chitin biosynthesis, Typ 1, e.g., Buprofezin;
(17) Molting disruptor (including for dipteras, two-winged insects), e.g., Cyromazin;
(18) Ecdyson receptor agonists, e.g., Chromafenozid, Halofenozid, Methoxyfenozid and Tebufenozid;
(19) Octopamin-receptor-agonists, e.g., Amitraz;
(20) Mitochondrial complex III electron transport inhibitors, e.g., Hydramethylnon, Acequinocyl and Fluacrypyrim;
(21) Mitochondrial complex I electron transport inhibitors, preferably so-called METI-acaricides, e.g., Fenazaquin, Fenpyroximat, Pyrimidifen, Pyridaben, Tebufenpyrad and Tolfenpyrad, or Rotenon (Derris);
(22) Voltage-dependent sodium channel blockers, e.g., Indoxacarb and Metaflumizone;
(23) Inhibitors of acetyl-CoA carboxylase, e.g., tetronic and tetramic acid derivatives such as Spirodiclofen, Spiromesifen, Spirotetramat and Spidoxamate (IUPAC Name: 1 l-(4-chloro-2,6-xylyl)-12-hydroxy-1,4-dioxa-9-azadispiro[4.2.4.2]tetradec-11-en-10-one);
(24) Mitochondrial complex IV electron transport inhibitors, e.g., Phosphines such as Aluminiumphosphid, Calciumphosphid, Phosphin and Zinkphosphid, or Cyanides such as Calciumcyanid, Potassiumcyanid and Sodiumcyanid;
(25) Mitochondrial complex II electron transport inhibitors, e.g., beta-Ketonitrilderivate such as Cyenopyrafen and Cyflumetofen, or Carboxanilide such as Pyflubumid;
(26) Ryanodinreceptor-modulators, e.g., Diamide such as Chlorantraniliprol, Cyantraniliprol and Flubendiamid;
(27) Modulators of chordotonal organs (with undefined target structure), e.g., Flonicamid.
(28) other active ingredients selected from Acynonapyr, Afidopyropen, Afoxolaner, Azadirachtin, Benclothiaz, Benzoximat, Benzpyrimoxan, Bifenazat, Broflanilid, Bromopropylat, Chinomethionat, Chloroprallethrin, Cryolit, Cyclaniliprol, Cycloxaprid, Cyhalodiamid, Dicloromezotiaz, Dicofol, Dimpropyridaz, epsilon-Metofluthrin, epsilon-Momfluthrin, Flometoquin, Fluazaindolizin, Fluensulfon, Flufenerim, Flufenoxystrobin, Flufiprol, Fluhexafon, Fluopyram, Flupyrimin, Fluralaner, Fluxametamid, Fufenozid, Guadipyr, Heptafluthrin, Imidaclothiz, Iprodione, Isocycloseram, kappa-Bifenthrin, kappa-Tefluthrin, Lotilaner, Meperfluthrin, Oxazosulfyl, Paichongding, Pyridalyl, Pyrifluquinazon, Pyriminostrobin, Spirobudiclofen, Spiropidion, Tetramethylfluthrin, Tetraniliprol, Tetrachlorantraniliprol, Tigolaner, Tioxazafen, Thiofluoximat and lodmethan; products from Bacillus firmus (1-1582, BioNeem, Votivo), as well as following compounds: 1-{2-Fluor-4-methyl-5-[(2,2,2-trifluorethyl)sulfinyl]phenyl}-3-(trifluormethyl)-1H-1,2,4-triazol-5-amin (known from WO2006/043635) (CAS 885026-50-6), {1′-[(2E)-3-(4-Chlorphenyl)prop-2-en-1-yl]-5-fluorspiro [indol-3,4′-piperidin]-1 (2H)-yl}(2-chlorpyridin-4-yl)methanon (known from WO2003/106457) (CAS 637360-23-7), 2-Chlor-N-[2-{l-[(2E)-3-(4-chlorphenyl)prop-2-en-1-yl]piperidin-4-yl}-4-(trifluormethyl)phenyl]isonicotinamid (known from WO2006/003494) (CAS 872999-66-1), 3-(4-Chlor-2,6-dimethylphenyl)-4-hydroxy-8-methoxy-1,8-diazaspiro[4.5]dec-3-en-2-on (known from WO 2010052161) (CAS 1225292-17-0), 3-(4-Chlor-2, 6-dimethylphenyl)-8-methoxy-2-oxo-1,8-diazaspiro[4.5]dec-3-en-4-yl-ethylcarbonat (known from EP 2647626) (CAS-1440516-42-6), 4-(But-2-in-1-yloxy)-6-(3,5-dimethylpiperidin-1-yl)-5-fluoropyrimidin (known from WO2004/099160) (CAS 792914-58-0), PF1364 (known from JP2010/018586) (CAS-Reg.No. 1204776-60-2), (3E)-3-[1-[(6-Chlor-3-pyridyl)methyl]-2-pyridyliden]-1,1,1-trifluorpropan-2-on (known from WO2013/144213) (CAS 1461743-15-6), N-[3-(Benzylcarbamoyl)-4-chlorphenyl]-1-methyl-3-(pentafluorethyl)-4-(trifluormethyl)-1H-pyrazol-5-carboxamid (known from WO2010/051926) (CAS 1226889-14-0), 5-Brom-4-chlor-N-[4-chlor-2-methyl-6-(methylcarbamoyl)phenyl]-2-(3-chlor-2-pyridyl)pyrazol-3-carboxamid (known from CN103232431) (CAS 1449220-44-3), 4-[5-(3,5-Dichlorphenyl)-4,5-dihydro-5-(trifluormethyl)-3-isoxazolyl]-2-methyl-N-(cis-1-oxido-3-thietanyl)benzamid, 4-[5-(3′,5-Dichlorphenyl)-4,5-dihydro-5-(trifhiormethyl)-3-isoxazolyl]-2-methyl-N-(trans-1-oxido-3- thietanyl)benzamid and 4-[(5S)-5-(3,5-Dichlorphenyl)-4, 5-dihydro-5-(trifluormethyl)-3-isoxazolyl]-2-methyl-N-(cis-1-oxido-3-thietanyl)benzamid (known from WO 2013/050317 A1) (CAS 1332628-83-7), N-[3-Chlor-1-(3-pyridinyl)-1H-pyrazol-4-yl]-N-ethyl-3-[(3,3,3-trifluorpropyl)sulfinyl]propanamid, (+)-N-[3-Chlor-1-(3-pyridinyl)-1H-pyrazol-4-yl]-N-ethyl-3-[(3,3,3-trifluorpropyl)sulfinyl]propanamid and (−)-N-[3-Chlor-1-(3-pyridinyl)-1H-pyrazol-4-yl]-N-ethyl-3-[(3,3,3-trifluorpropyl)sulfinyl]propanamid (known from WO 2013/162715 A2, WO 2013/162716 A2, US 2014/0213448 A1) (CAS 1477923-37-7), 5-[[(2E)-3-Chlor-2-propen-1-yllamino]-1-[2,6-dichlor-4-(trifluormethyl)phenyl]-4-[(trifluormethyl)sulfmyl]-1H-pyrazol-3-carbonitrile (known from CN 101337937 A) (CAS 1105672-77-2), 3-Brom-N-[4-chlor-2-methyl-6-[(methylamino)thioxomethyl]phenyl]-1-(3-chlor-2-pyridinyl)-1H-pyrazol-5-carboxamid, (Liudaibenjiaxuanan, known from CN 103109816 A) (CAS 1232543-85-9); N-[4-Chlor-2-[[(1, 1-dimethylethyl)amino]carbonyl]-6-methylphenyl]-1-(3-chlor-2-pyridinyl)-3-(fluormethoxy)-1H-pyrazol-5-carboxamid (known from WO 2012/034403 A1) (CAS 1268277-22-0), N-[2-(5-Amino-1,3,4-thiadiazol-2-yl)-4-chlor-6-methylphenyl]-3-brom-1-(3-chlor-2-pyridinyl)-1H-pyrazol-5-carboxamid (known from WO 2011/085575 A1) (CAS 1233882-22-8), 4-[3-[2,6-Dichlor-4-[(3,3-dichlor-2-propen-1-yl)oxy]phenoxy]propoxy]-2-methoxy-6-(trifluormethyl)pyrimidin (known from CN 101337940 A) (CAS 1108184-52-6); (2E)- and 2(Z)-2-[2-(4-Cyanophenyl)-1-[3-(trifluormethyl)phenyl]ethyliden]-N-[4-(difluormethoxy) phenyl]hydrazincarboxamid (known from CN 101715774 A) (CAS 1232543-85-9); Cyclopropancarbonsaure-3-(2,2-dichlorethenyl)-2,2-dimethyl-4-(1H-benzimidazol-2-yl)phenylester (known from CN 103524422 A) (CAS 1542271-46-4); (4aS)-7-Chlor-2,5-dihydro-2-[[(methoxycarbonyl)[4-[(trifluormethyl)thio]phenyl]amino]carbonyl]indeno[1,2-e][1,3,4]oxadiazin-4a(3H)-carbonsauremethylester (known from CN 102391261 A) (CAS 1370358-69-2); 6-Desoxy-3-O-ethyl-2,4-di-O-methyl-1-[N-[4-[1-[4-(1,1,2,2,2-pentafluorethoxy)phenyl]-1H-1,2,4-triazol-3-yl]phenyl]carbamat]-a-L-mannopyranose (known from US 2014/0275503 A1) (CAS 1181213-14-8); 8-(2-Cyclopropylmethoxy-4-trifluormethylphenoxy)-3-(6-trifluormethylpyridazin-3-yl)-3-azabicyclo[3.2.1]octan (CAS 1253850-56-4), (8-anti)-8-(2-Cyclopropylmethoxy-4-trifluormethylphenoxy)-3-(6-trifluormethylpyridazin-3-yl)-3-azabicyclo [3.2.1]octan (CAS 933798-27-7), (8-syn)-8-(2-Cyclopropylmethoxy-4-trifluormethylphenoxy)-3-(6-trifluormethylpyridazin-3-yl)-3-azabicyclo[3.2.1]octan (known from WO 2007040280 A1, WO 2007040282 A1) (CAS 934001-66-8), N-[3-Chlor-1-(3-pyridinyl)-1H-pyrazol-4-yl]-N-ethyl-3-[(3,3,3-trifluorpropyl)thio]-propanamid (known from WO 2015/058021 A1, WO 2015/058028 A1) (CAS 1477919-27-9) and N-[4-(Aminothioxomethyl)-2-methyl-6-[(methylamino)carbonyl]phenyl]-3-bromo-1-(3-chloro-2-pyridinyl) 1H-pyrazol-5-carboxamid (known from CN 103265527 A) (CAS 1452877-50-7), 5-(1,3-Dioxan-2-yl)-4-[[4-(trifluormethyl)phenyl]methoxy]-pyrimidin (known from WO 2013/115391 A1) (CAS 1449021-97-9), 3-(4-Chlor-2,6-dimethylphenyl)-8-methoxy-1-methyl-1,8-diazaspiro[4.5]decane-2,4-dion (known from WO 2014/187846 A1) (CAS 1638765-58-8), 3-(4-Chlor-2,6-dimethylphenyl)-8-methoxy-1-methyl-2-oxo-1,8-diazaspiro[4.5]dec-3-en-4-yl-carbonsaureethylester (known from WO 2010/066780 A1, WO 2011151146 A1) (CAS 1229023-00-0), 4-[(5S)-5-(3,5-Dichlor-4-fluorophenyl)-4, 5-dihydro-5-(trifluoromethyl)-3- isoxazolyl]-N-[(4R)-2-ethyl-3-oxo-4-isoxazolidinyl]-2-methyl-benzamid (known from WO 2011/067272, WO2013/050302) (CAS 1309959-62-3).

Examples of herbicides according to the invention include but are not limited to: Acetochlor, acifluorfen, acifluorfen-sodium, aclonifen, alachlor, allidochlor, alloxydim, alloxydim-sodium, ametryn, amicarbazone, amidochlor, amidosulfuron, 4-amino-3-chloro-5-fluoro-6-(7-fluoro-1H-indol-6-yl)pyridine-2-carboxylic acid, aminocyclopyrachlor, aminocyclopyrachlor-potassium, aminocyclopyrachlor-methyl, aminopyralid, amitrole, ammoniumsulfamate, anilofos, asulam, atrazine, azafenidin, azimsulfuron, beflubutamid, benazolin, benazolin-ethyl, benfluralin, benfuresate, bensulfuron, bensulfuron-methyl, bensulide, bentazone, benzobicyclon, benzofenap, bicyclopyron, bifenox, bilanafos, bilanafos-sodium, bispyribac, bispyribac-sodium, bixlozone, bromacil, bromobutide, bromofenoxim, bromoxynil, bromoxynil-butyrate, -potassium, -heptanoate, and -octanoate, busoxinone, butachlor, butafenacil, butamifos, butenachlor, butralin, butroxydim, butylate, cafenstrole, carbetamide, carfentrazone, carfentrazone-ethyl, chloramben, chlorbromuron, 1-{2-chloro-3-[(3-cyclopropyl-5-hydroxy-1-methyl-1H-pyrazol-4-yl)carbonyl]-6-(trifluormethyl)phenyl}piperidin-2-on, 4-{2-chloro-3-[(3,5-dimethyl-1H-pyrazol-1-yl)methyl]-4-(methylsulfonyl)benzoyl}-1,3-dimethyl-1H-pyrazol-5-yl-1,3-dimethyl-1H-pyrazol-4-carboxylat, chlorfenac, chlorfenac-sodium, chlorfenprop, chlorflurenol, chlorflurenol-methyl, chloridazon, chlorimuron, chlorimuron-ethyl, 2-[2-chloro-4-(methylsulfonyl)-3-(morpholin-4-ylmethyl)benzoyl]-3-hydroxycyclohex-2-en-1-on, 4-{2-chloro-4-(methylsulfonyl)-3-[(2,2,2-trifluorethoxy)methyl]benzoyl}-1-ethyl-1H-pyrazol-5-yl-1,3-dimethyl-1H-pyrazol-4-carboxylat, chlorophthalim, chlorotoluron, chlorthal-dimethyl, 3-[5-chloro-4-(trifluormethyl)pyridine-2-yl]-4-hydroxy-1-methylimidazolidine-2-on, chlorsulfuron, cinidon, cinidon-ethyl, cinmethylin, cinosulfuron, clacyfos, clethodim, clodinafop, clodinafop-propargyl, clomazone, clomeprop, clopyralid, cloransulam, cloransulam-methyl, cumyluron, cyanamide, cyanazine, cycloate, cyclopyranil, cyclopyrimorate, cyclosulfamuron, cycloxydim, cyhalofop, cyhalofop-butyl, cyprazine, 2,4-D, 2,4-D-butotyl, -butyl,-dimethylammonium, -diolamin, -ethyl, -2-ethylhexyl, -isobutyl, -isooctyl, -isopropylammonium,-potassium, -triisopropanolammonium, and -trolamine, 2,4-DB, 2,4-DB-butyl, -dimethylammonium,-isooctyl, -potassium, and -sodium, daimuron (dymron), dalapon, dazomet, n-decanol, desmedipham, detosyl-pyrazolate (DTP), dicamba, dichlobenil, dichlorprop, dichlorprop-P, diclofop, diclofop-methyl, diclofop-P-methyl, diclosulam, difenzoquat, diflufenican, diflufenzopyr, diflufenzopyr-sodium, dimefuron, dimepiperate, dimethachlor, dimethametryn, dimethenamid, dimethenamid-P, 3-(2,6-dimethylphenyl)-6-[(2-hydroxy-6-oxocyclohex-1-en-1-yl)carbonyl]-1-methylchinazolin-2,4(1H,3H)-dion, 1,3-dimethyl-4-[2-(methylsulfonyl)-4-(trifluormethyl)benzoyl]-1H-pyrazol-5-yl-1,3-dimethyl-1H-pyrazol-4-carboxylat, dimetrasulfuron, dinitramine, dinoterb, diphenamid, diquat, diquat-dibromid, dithiopyr, diuron, DMPA, DNOC, endothal, EPTC, esprocarb, ethalfluralin, ethametsulfuron, ethametsulfuron-methyl, ethiozin, ethofumesate, ethoxyfen, ethoxyfen-ethyl, ethoxysulfuron, etobenzanid, ethyl-[(3-{2-chloro-4-fluoro-5-[3-methyl-2,6-dioxo-4-(trifluormethyl)-3,6-dihydropyrimidin-1(2H)-yl]phenoxy}pyridin-2-yl)oxy]acetat, F-9960, F-5231, i.e., N-{2-chloro-4-fluoro-5-[4-(3-fluoropropyl)-5-oxo-4,5-dihydro-1H-tetrazol-1-yl]phenyl}ethanesulfonamide, F-7967, i.e., 3-[7-chloro-5-fluoro-2-(trifluoromethyl)-1H-benzimidazol-4-yl]-1-methyl-6-(trifluoromethyl)pyrimidine-2,4(1H,3H)-dione, fenoxaprop, fenoxaprop-P, fenoxaprop-ethyl, fenoxaprop-P-ethyl, fenoxasulfone, fenquinotrione, fentrazamide, flamprop, flamprop-M-isopropyl, flamprop-M-methyl, flazasulfuron, florasulam, fluazifop, fluazifop-P, fluazifop-butyl, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, flurenol, flurenol-butyl, -dimethylammonium and -methyl, fluoroglycofen, fluoroglycofen-ethyl, flupropanate, flupyrsulfuron, flupyrsulfuron-methyl-sodium, fluridone, fluro-chloridone, fluroxypyr, fluroxypyr-meptyl, flurtamone, fluthiacet, fluthiacet-methyl, fomesafen, fomesafen-sodium, foramsulfuron, fosamine, glufosinate, glufosinate-ammonium, glufosinate-P-sodium, glufosinate-P-ammonium, glufosinate-P-sodium, glyphosate, glyphosate-ammonium, -isopropylammonium, -diammonium,-dimethylammonium, -potassium, -sodium, and -trimesium, H-9201, i.e., 0-(2,4-dimethyl-6-nitrophenyl)O-ethyl isopropylphosphoramidothioate, halauxifen, halauxifen-methyl,halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e., 1-(dimethoxyphosphoryl) ethyl-(2,4-dichlorophenoxy)acetate, 4-hydroxy-1-methoxy-5-methyl-3-[4-(trifluormethyl)pyridine-2-yl]imidazolidine-2-on, 4-hydroxy-1-methyl-3-[4-(trifluormethyl)pyridine-2-yl]imidazolidine-2-on, (5-hydroxy-1-methyl-1H-pyrazol-4-yl)(3,3,4-trimethyl-1,1-dioxido-2, 3-dihydro-1-benzothiophen-5-yl)methanon, 6-[(2-hydroxy-6-oxocyclohex-1-en-1-yl)carbonyl]-1,5-dimethyl-3-(2-methylphenyl)chinazolin-2,4(1H,3H)-dion, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-immonium, imazosulfuron, indanofan, indaziflam, iodosulfuron, iodosulfuron-methyl-sodium, ioxynil, ioxynil-octanoate, -potassium and -sodium, ipfencarbazone, isoproturon, isouron, isoxaben, isoxaflutole, karbutilate, KUH-043, i.e., 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, keto-spiradox, lactofen, lenacil, linuron, MCPA, MCPA-butotyl, -dimethylammonium, -2-ethylhexyl, -isopropylammonium, -potassium, and -sodium, MCPB, MCPB-methyl, -ethy,1 and -sodium, mecoprop, mecoprop-sodium, and -butotyl, mecoprop-P, mecoprop-P-butotyl, -dimethylammonium, -2-ethylhexyl, and -potassium, mefenacet, mefluidide, mesosulfuron, mesosulfuron-methyl, mesotrione, methabenzthiazuron, metam, metamifop, metamitron, metazachlor, metazosulfuron, methabenzthiazuron, methiopyrsulfuron, methiozolin, 2-({2-[(2-methoxyethoxy)methyl]-6-(trifluormethyl)pyridin-3-yl}carbonyl)cyclohexan-1,3-dion, methyl isothiocyanate, 1-methyl-4-[(3,3,4-trimethyl-1,1-dioxido-2,3-dihydro-1-benzothiophen-5-yl)carbonyl]-1H-pyrazol-5-ylpropan-1-sulfonat, metobromuron, metolachlor, S-metolachlor, metosulam, metoxuron, metribuzin, metsulfuron, metsulfuron-methyl, molinat, monolinuron, monosulfuron, monosulfuron-ester, MT-5950, i.e., N-(3-chloro-4-isopropylphenyl)-2-methylpentan amide, NGGC-011, napropamide, NC-310, i.e., [5-(benzyloxy)-1-methyl-1H-pyrazol-4-yl](2,4-dichlorophenyl)-methanone, neburon, nicosulfuron, nonanoic acid (pelargonic acid), norflurazon, oleic acid (fatty acids), orbencarb, orthosulfamuron, oryzalin, oxadiargyl, oxadiazon, oxasulfuron, oxaziclomefon, oxyfluorfen, paraquat, paraquat dichloride, pebulate, pendimethalin, penoxsulam, pentachlorphenol, pentoxazone, pethoxamid, petroleum oils, phenmedipham, picloram, picolinafen, pinoxaden, piperophos, pretilachlor, primisulfuron, primisulfuron-methyl, prodiamine, profoxydim, prometon, prometryn, propachlor, propanil, propaquizafop, propazine, propham, propisochlor, propoxy-carbazone, propoxycarbazonesodium, propyrisulfuron, propyzamide, prosulfocarb, prosulfuron, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimi-sulfan, pyrithiobac, pyrithiobac-sodium, pyroxasulfone, pyroxsulam, quinclorac, quinmerac, quino-clamine, quizalofop, quizalofop-ethyl, quizalofop-P, quizalofop-P-ethyl, quizalofop-P-tefuryl, QYM-201, QYR-301, rimsulfuron, saflufenacil, sethoxydim, siduron, simazine, simetryn, SL-261, sulcotrion, sulfentrazone, sulfometuron, sulfometuron-methyl, sulfosulfuron, SYN-523, SYP-249, i.e., 1-ethoxy-3-methyl-1-oxobut-3-en-2-yl 5-[2-chloro-4-(trifluoromethyl)phenoxy]-2-nitrobenzoate, SYP-300, i.e., 1-[7-fluoro-3-oxo-4-(prop-2-yn-1-yl)-3,4-dihydro-2H-1,4-benzoxazin-6-yl]-3-propyl-2-thioxoimidazolidine-4, 5-dione, 2,3,6-TBA, TCA (trichloroacetic acid), TCA-sodium, tebuthiuron, tefuryltrione, tembotrione, tepraloxydim, terbacil, terbucarb, terbumeton, terbuthylazin, terbutryn, tetflupyrolimet, thenylchlor, thiazopyr, thiencarbazone, thiencarbazone-methyl, thifensulfuron, thifensulfuron-methyl, thiobencarb, tiafenacil, tolpyralate, topramezone, tralkoxydim, triafamone, tri-allate, triasulfuron, triaziflam, tribenuron, tribenuron-methyl, triclopyr, trietazine, trifloxysulfuron, trifloxysulfuron-sodium, trifludimoxazin, trifluralin, triflusulfuron, triflusulfuron-methyl, tritosulfuron, urea sulfate, vernolate, ZJ-0862, i.e., 3,4-dichloro-N-{2-[(4,6-dimethoxypyrimidin-2-yl)oxy]benzyl}aniline.

In certain embodiments, the active agricultural ingredient is a fungicide or a mixture of one or more fungicides. In certain embodiments, the active agricultural ingredient is an insecticide, or a mixture of one or more insecticides. In certain embodiments, the active agricultural ingredient is an herbicide, or a mixture of two or more herbicides. In certain embodiments, the active agricultural ingredient comprises a mixture of two or more different types of components, for example, a fungicide and an insecticide, or an herbicide and a fungicide. Additional iterations of mixtures are also envisioned, comprising any number and/or any type of such ingredients.

All named active ingredients as described above can be present in the form of the free compound or, if their functional groups enable this, an agrochemically active salt thereof.

Furthermore, mesomeric forms as well as stereoisomeres or enantiomeres, where applicable, shall be enclosed, as these modifications are well known to the skilled artisan, as well as polymorphic modifications.

If not otherwise specified, in the present invention solid, agrochemical active compounds are to be understood as meaning all substances customary for plant treatment, whose melting point is above 20° C.

The adjuvant compositions of the subject invention preferably boost the activity of active agricultural chemical(s), e.g., pesticides, and/or enhance their efficacy, preferably by more than 5%, and more preferably by more than 10%, relative to use without the adjuvant composition

In some embodiments, use of the adjuvant composition with a pesticide produces a synergistic effect, wherein the total efficacy of the agricultural application comprising the adjuvant and the pesticide is greater than the efficacy of either component alone, and greater than merely an additive effect of the components. The efficacy is relative both to the total amount and to the relative ratios. In some embodiments, a desired level of enhanced efficacy is obtained at a ratio of active ingredient to adjuvant of 1:200 to 1:1, 1:100 to 50:1, or from 1:75 to 4:1.

In certain embodiments, the application dosage of a tank mix formulation of an agricultural composition comprising the adjuvant composition is a spray volume between 1 and 20 l/ha, preferably 2 and 15 l/ha, more preferably 5 and 15 l/ha, and the amount of the adjuvant composition is present in 5 to 250 g/l, from 8 to 120 g/l, or from 10 to 80 g/l, and wherein the active agricultural component is present from 5 to 500 g/1, from 10 to 300 g/l, or from 20 to 200 g/l.

In some embodiments, the concentration at which the adjuvant composition is employed imparts no pesticidal activity itself, while in other embodiments, the adjuvant composition is employed at a concentration such that the adjuvant composition imparts a non-zero level of pesticidal activity.

The adjuvant composition, agricultural chemical, and/or an agricultural composition formed by the two of these combined, can be formulated as suspension concentrates, aqueous suspensions, suspo-emulsions or capsule suspensions, emulsion concentrates, water dispersible granules, oil dispersions, emulsifiable concentrates, dispersible concentrates, wettable granules, wherein in the case of non-aqueous formulations or solid formulations a sprayable formulation can be obtained by adding a liquid carrier such as water.

In certain embodiments, the agricultural composition can comprise additional substances, such as, for example, water, carriers, pH adjusters, microbial inoculants, mineral sources, plant seeds, dyes, stabilizers, emulsifiers, prebiotics, polymers, buffering agents, viscosity modifiers, preservatives, nutrients for plant and/or beneficial microbe growth, tracking agents, biocides, surfactants, lubricants, solubility controlling agents, preservatives, and ultra-violet light resistant agents.

The pH of the composition should be suitable for the components of interest as well as for the plant and/or soil environment to which it will be applied. In some embodiments, the pH is about 2.0 to about 10.0, about 2.0 to about 9.5, about 2.0 to about 9.0, about 2.0 to about 8.5, about 2.0 to about 8.0, about 2.0 to about 7.5, about 2.0 to about 7.0, about 3.0 to about 7.5, about 4.0 to about 7.5, about 5.0 to about 7.5, about 5.5 to about 7.0, about 6.5 to about 7.5, about 3.0 to about 5.5, about 3.25 to about 4.0, or about 3.5. In certain embodiments, the pH is less than 6.0, e.g., about 2.0 to about 5.5. In certain other embodiments, the pH is greater than 6.0, e.g., about 8.5 to 12.0. Buffers, and pH regulators, such as carbonates and phosphates, may be used to stabilize pH near a preferred value.

In certain embodiments, carriers used according to the subject invention are those which can customarily be used for this purpose in agrochemical formulations. A carrier is a solid or liquid, natural or synthetic, organic or inorganic substance that is generally inert, and which may be used as a solvent. The carrier generally improves the application of the compounds, for instance, to plants, plants parts or seeds. Examples of suitable solid carriers include, but are not limited to, ammonium salts, in particular ammonium sulfates, ammonium phosphates and ammonium nitrates, natural rock flours, such as kaolins, clays, talc, chalk, quartz, attapulgite, montmorillonite and diatomaceous earth, silica gel and synthetic rock flours, such as finely divided silica, alumina and silicates. Examples of typically useful solid carriers for preparing granules include, but are not limited to crushed and fractionated natural rocks such as calcite, marble, pumice, sepiolite and dolomite, synthetic granules of inorganic and organic flours and granules of organic material such as paper, sawdust, coconut shells, maize cobs and tobacco stalks. Preferred solid carriers are selected from clays, talc and silica.

Examples of suitable liquid carriers include, but are not limited to, water, organic solvents and combinations thereof. Examples of suitable solvents include polar and nonpolar organic chemical liquids, for example from the classes of alcohols and polyols (which may optionally also be substituted, etherified and/or esterified, such as ethanol, propanol, butanol, benzylalcohol, cyclohexanol or glycol, 2-ethyl hexanol), ethers such as dioctyl ether, tetrahydrofuran, dimethyl isosorbide, solketal, cyclopentyl methyl ether, solvents offered by Dow under the Dowanol Product Range e.g., Dowanol DPM, anisole, phenetole, different molecular weight grades of dimethyl polyethylene glycol, different molecular weight grades of dimethyl polypropylene glycol, dibenzyl ether ketones (such as acetone, methyl ethyl ketone, methyl isobutyl ketone, cyclopentanone, cyclohexanone, cycloheptanone, acetophenone, propiophenone), lactate esters, such as methyl lactate, ethyl lactate, propyl lactate, butyl lactate, 2-ethyl hexyl lactate (poly)ethers such as different molecular weight grades of polyethylene glycol, different molecular weight grades of polypropylene glycol unsubstituted and substituted amines amides (such as dimethylformamide, or N,N-dimethyl lactamide, or N-formyl morpholine, or fatty acid amides such N,N-dimethyl decanamide or N,N-dimethyl dec-9-en-amide) and esters thereof lactams (such as 2-pyrrolidone, or N-alkylpyrrolidones, such as N-methylpyrrolidone, or N-butylpyrrolidone, or N-octylpyrrolidone, or N-dodecylpyrrolidone or N-methyl caprolactam, N-alkyl caprolactam) lactones (such as gamma-butyrolactone, gamma-valerolactone, delta-valerolactone, or alphamethyl gamma-butyrolactone sulfones and sulfoxides (such as dimethyl sulfoxide), nitriles, such as linear or cyclic alkyl nitriles, in particular acetonitrile, cyclohexane carbonitrile, octanonitrile, dodecanonitrile). linear and cyclic carbonates, such as diethyl carbonate, dipropyl carbonate, dibutyl carbonate, dioctyl carbonate, or ethylene carbonate, propylene carbonate, butylene carbonate, glycerine carbonate.

In preferred embodiments, the carrier is water, including any available source of water, such as rivers, lakes, and groundwater, and can include, for example, any potable water, some non-potable waters, and recycled water, such as the water from run-off.

### Methods for Enhancing Agrochemical Efficacy

The subject invention also provides methods for enhancing the efficacy of an active agricultural ingredient in comparison to the active agricultural ingredient when used alone, wherein an adjuvant composition of the subject invention is administered to a plant and/or the plant's surrounding environment either before, simultaneously with, or after the active agricultural ingredient. Thus, the subject invention also provides methods for delivering an active agricultural chemical to plants and/or their surrounding environment to provide a benefit to the plant and/or environment, wherein the benefit is enhanced due to the use of the adjuvant composition. The benefit can be, for example, pest control, nutrient fertilization, irrigation, plant growth, and others.

According to the subject methods, the adjuvant and the active agricultural ingredient can be mixed together prior to administration to produce an agricultural composition as, for example, a sprayable tank mix. In some embodiments, the two components are applied individually but in such a way as to produce the agricultural composition at the point of administration. In such embodiments, the methods comprise applying the two components within, for example, 24 hours, preferably within 12 hours, more preferably within 60 minutes before or after one another.

The subject methods can improve efficacy of the active agricultural chemical by at least 1%, 5%, 10%, 15%, 20%, 25%, 30%, 40%, or at least 50% compared with methods in which the chemical is applied without the adjuvant. Improved efficacy can include, for example, reduced dosage, greater pest control, increased plant yields, reduced water usage, and other quantitative or qualitative measures of efficacy.

In certain embodiments, the subject methods also comprise performing one or more measurements to assess the effect of the methods of the subject invention on the enhancing of pesticide efficacy. For example, comparing water usage rates, pesticide usage rates, pest population per unit area and/or plant growth rates between adjuvant-treated and untreated plants/areas are ways that performance of the adjuvant could be tested.

Measurements can be conducted at a certain time point after application thereof to the site. In some embodiments, the measurements are conducted after about 1 week or less, 2 weeks or less, 3 weeks or less, 4 weeks or less, 30 days or less, 60 days or less, 90 days or less, 120 days or less, 180 days or less, and/or 1 year or less.

Furthermore, the measurements can be repeated over time. In some embodiments, the measurements are repeated daily, weekly, monthly, bi-monthly, semi-monthly, semi-annually, and/or annually.

The methods and compositions of the subject invention can be used either alone or in combination with other compounds for, e.g., efficiently enhancing soil and/or plant health. For example, in some embodiments, the method comprises applying additional components, including additional herbicides, fertilizers, pesticides, soil amendments, irrigation additives and/or plant growth regulators to the soil and/or plants. The exact materials and the quantities thereof can be determined by, for example, a grower or soil scientist having the benefit of the subject disclosure.

### Modes of Application

As used herein, “applying” a composition or product to a site refers to contacting a composition or product with a site such that the composition or product can have an effect on that site. The mode of application depends upon the formulation of the composition, and can include, for example, spraying, pouring, sprinkling, injecting, spreading, mixing, dunking, fogging and misting.

The adjuvant composition, agricultural chemical, and/or an agricultural composition formed by the two of these combined, can be formulated as suspension concentrates, aqueous suspensions, suspo-emulsions or capsule suspensions, emulsion concentrates, water dispersible granules, oil dispersions, emulsifiable concentrates, dispersible concentrates, wettable granules, dry, flowable and/or wettable powders, pellets, microcapsules, steaks, gels, pastes and/or aerosols, wherein in the case of non-aqueous formulations or solid formulations a sprayable formulation can be obtained by adding a liquid carrier such as water.

In certain embodiments, the application dosage of the adjuvant is between 1-5000 ml/ha, between 25-1000 ml/ha, between 50-750 ml/ha or between 100 and 500 ml/ha.

In certain embodiments, the application dosage of a tank mix formulation comprising the adjuvant composition is a spray volume between 1 and 20 l/ha, 2 and 15 l/ha, or 5 and 15 l/ha, and wherein the amount of the adjuvant composition is present in 5 to 250 g/1, 8 to 120 g/1, or 10 to 80 g/1, and wherein the active component is present from 5 to 500 g/1, from 10 to 300 g/l, or from 20 to 200 g/1.

In one embodiment, the site to which a composition of the subject invention is applied is soil (or rhizosphere), including soil in which plants will be planted or are growing (e.g., a crop, a field, an orchard, a grove, a pasture/prairie or a forest). The composition(s) of the subject invention can be pre-mixed with irrigation fluids, and/or the composition(s) can be applied to soil surfaces, with or without water, where the beneficial effect of the soil application can be activated by rainfall, sprinkler, flood, drip or other forms of irrigation.

In one embodiment, the site is a plant or plant part. The composition(s) can be applied directly thereto as a seed treatment, or to the surface of a plant or plant part (e.g., to the surface of the roots, tubers, stems, flowers, leaves, fruit, or flowers). In one embodiment, the composition(s) can be contacted with one or more roots of the plant. The composition(s) can be applied directly to the roots, e.g., by spraying or dunking the roots prior to planting, and/or indirectly, e.g., by administering the composition(s) to the soil in which the plant grows. The composition(s) can be applied to the seeds of the plant prior to or at the time of planting, or to any other part of the plant and/or its surrounding environment.

In one embodiment, wherein the method is used in a field, citrus grove, a pasture or prairie, a forest, a sod or turf farm, lawn, or another agricultural crop, the method can comprise administering the composition(s) into an irrigation system used for supplying water, fertilizers, pesticides or other liquid compositions. Thus, the plant and/or soil can be treated with the composition via, for example, soil injection, soil drenching, using a center pivot irrigation system, with a spray over the seed furrow, with micro-jets, with drench sprayers, with boom sprayers, with sprinklers, with drip irrigators and/or any other type of irrigation system. Advantageously, the method is suitable for treating hundreds or more acres of land.

In one embodiment, wherein the method is used in a smaller scale setting, the method can comprise administering the composition(s) (mixed with water and other optional additives) from a handheld lawn and garden sprayer and spraying soil or another site with the composition. The composition(s) can also be mixed into a standard handheld watering can and poured onto a site.

In certain preferred embodiments, the composition is applied at a tank mix by spraying, including via, for example, unmanned aerial systems (UAS), or drones, unmanned guided vehicles, boom sprayers, rotating disc droplet applicators, or other methods of spraying known in the agricultural arts.

Soil, plants and/or their environments can be treated at any point during the process of cultivating a plant. For example, the composition(s) can be applied to the soil prior to, concurrently with, or after the time when seeds or plants are planted therein. They can also be applied at any point thereafter during the development and growth of the plant, including when the plant is flowering, fruiting, and during and/or after abscission of leaves.

In one embodiment, the methods and compositions according to the subject invention lead to an increase in one or more of: root mass, stalk diameter, plant height, canopy density, chlorophyll content, flower count, bud count, bud size, bud density, leaf surface area, and/or nutrient uptake of a plant, by at least 1%, 5%, 10%, 20%, 30%, 40%, 50%, 60%, 70%, 80%, 90%, 100%, 150%, 200%, or more, compared to a plant growing in an untreated environment.

In certain embodiments, the subject invention provides methods for controlling pests, wherein a pesticidal component, such as one described above, is applied to the pest and/or its environment in the presence of an adjuvant composition according to the subject invention.

### Production of Biosurfactants According to the Subject Invention

The subject invention utilizes methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

As used herein “fermentation” refers to cultivation or growth of cells under controlled conditions. The growth could be aerobic or anaerobic. In preferred embodiments, the microorganisms are grown using SSF and/or modified versions thereof.

In one embodiment, the subject invention provides materials and methods for the production of biomass (e.g., viable cellular material), extracellular metabolites (e.g., small molecules and proteins), residual nutrients and/or intracellular components (e.g., enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases).

Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source can be a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sunflower oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

The pH of the culture should be suitable for the microorganism of interest as well as for the soil environment to which the composition will be applied. In some embodiments, the pH is about 2.0 to about 10.0, about 2.0 to about 9.5, about 2.0 to about 9.0, about 2.0 to about 8.5, about 2.0 to about 8.0, about 2.0 to about 7.5, about 2.0 to about 7.0, about 3.0 to about 7.5, about 4.0 to about 7.5, about 5.0 to about 7.5, about 5.5 to about 7.0, about 6.5 to about 7.5, about 3.0 to about 5.5, about 3.25 to about 4.0, or about 3.5. Buffers, and pH regulators, such as carbonates and phosphates, may be used to stabilize pH near a preferred value.

In one embodiment, the method of cultivation is carried out at about 5° to about 100° C., about 150 to about 60° C., about 200 to about 50° C., about 200 to about 45° C., about 25° to about 40° C., about 25° to about 37° C., about 25° to about 35° C., about 300 to about 35° C., about 240 to about 28° C., or about 220 to about 25° C. In one embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The microbial growth by-product produced by microorganisms of interest may be retained in the microorganisms or secreted into the growth medium. The medium may contain compounds that stabilize the activity of microbial growth by-product.

The biomass content of the fermentation medium may be, for example, from 5 g/l to 180 g/l or more, or from 10 g/l to 150 g/l.

The cell concentration may be, for example, at least 1×10⁶ to 1×10¹³, 1×10⁷ to 1×10¹², 1×10⁸ to 1×10¹¹, or 1×10⁹ to 1×10¹⁰ CFU/ml.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

Advantageously, the microbe-based products can be produced in remote locations. The microbe growth facilities may operate off the grid by utilizing, for example, solar, wind and/or hydroelectric power.

### Preparation of Microbe-Based Products

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, different strains of microbe are grown separately and then mixed together to produce the microbe-based product. The microbes can, optionally, be blended with the medium in which they are grown and dried prior to mixing.

In one embodiment, the different strains are not mixed together, but are applied to a plant and/or its environment as separate microbe-based products.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, chelators, stabilizers, ultra-violet light resistant agents, other microbes and other suitable additives that are customarily used for such preparations.

In one embodiment, buffering agents including organic and amino acids or their salts, can be added. Suitable buffers include citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof. Phosphoric and phosphorous acids or their salts may also be used. Synthetic buffers are suitable to be used but it is preferable to use natural buffers such as organic and amino acids or their salts listed above.

In a further embodiment, pH adjusting agents include potassium hydroxide, ammonium hydroxide, potassium carbonate or bicarbonate, hydrochloric acid, nitric acid, sulfuric acid or a mixture.

In one embodiment, additional components such as an aqueous preparation of a salt, such as sodium bicarbonate or carbonate, sodium sulfate, sodium phosphate, sodium biphosphate, can be included in the formulation.

In certain embodiments, an adherent substance can be added to the composition to prolong the adherence of the product to plant parts. Polymers, such as charged polymers, or polysaccharide-based substances can be used, for example, xanthan gum, guar gum, levan, xylinan, gellan gum, curdlan, pullulan, dextran and others.

In preferred embodiments, commercial grade xanthan gum is used as the adherent. The concentration of the gum should be selected based on the content of the gum in the commercial product. If the xanthan gum is highly pure, then 0.001% (w/v—xanthan gum/solution) is sufficient.

In one embodiment, glucose, glycerol and/or glycerin can be added to the microbe-based product to serve as, for example, an osmoticum during storage and transport. In one embodiment, molasses can be included.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 200 C, 15° C., 10° C., or 5° C.

1. An agricultural adjuvant composition comprising a linear sophorolipid and a carrier.

2. The agricultural adjuvant composition of claim 1, wherein the carrier is water.

3. The agricultural adjuvant composition of claim 1, containing no lactonic sophorolipids.

4. The agricultural adjuvant composition of claim 1, which has the following General Formula
(A): 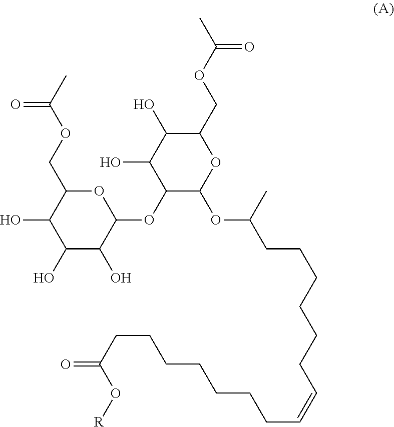
wherein R=an alcohol group selected from the group consisting of: 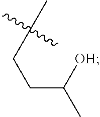 [SMILES: *CCC(C)O]
ethanol; methanol; heptanol; 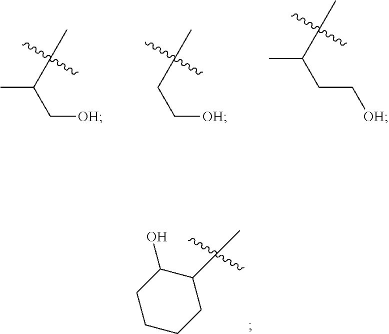
butanol; propanol; isopropanol; pentanol; hexanol; octanol; nonanol; and decanol.

5. An agricultural composition comprising an agricultural adjuvant composition according to claim 4, and an active agricultural ingredient selected from a pesticide, an herbicide, a fertilizer, an irrigation additive, a soil amendment, and a plant growth promoter.

6. The composition of claim 5, further comprising water.

7. The composition of claim 5, formulated as a suspension concentrate, aqueous suspension, suspo-emulsion, capsule suspension, emulsion concentrate, water dispersible granules, oil dispersion, emulsifiable concentrate, dispersible concentrate, wettable granules, dry, flowable and/or wettable powders, pellets, microcapsules, steaks, gels, pastes and/or aerosols.

8. The composition of claim 7, wherein in the case of non-aqueous formulations or solid formulations, a sprayable formulation is obtained by adding water.

9. The composition of claim 5, further comprising one or more of the following: pH adjusters, microbial inoculants, mineral sources, plant seeds, dyes, stabilizers, emulsifiers, prebiotics, polymers, buffering agents, viscosity modifiers, preservatives, nutrients for plant and/or beneficial microbe growth, tracking agents, biocides, surfactants, lubricants, solubility controlling agents, preservatives, and ultra-violet light resistant agents.

10. A method of enhancing the efficacy of an active agricultural ingredient, which comprises applying the active agricultural ingredient to the site in the presence of an adjuvant composition according to any of claim 4, wherein the active agricultural ingredient is selected from a pesticide, an herbicide, a fertilizer, an irrigation additive, a soil amendment, and a plant growth promoter.

11. The method of claim 10, wherein the active agricultural ingredient is a pesticide, and where efficacy is enhanced by one or more of the following: increasing the number of pests that are controlled by a given dosage of the pesticide, reducing the dosage required for the pesticide to be effective at controlling a given number of pests, reducing off-target drift of the pesticide, increasing the retention of the pesticide on plant parts, increasing the penetration of the pesticide, increasing the wetting, coverage and uptake of the pesticide, increasing the stability of the pesticide during storage, and reducing the foam produced during mixing and/or application of the pesticide.

12. The method of claim 10, wherein the active agricultural ingredient is applied separately in time from the adjuvant, but within 12 hours before or after the adjuvant.

13. The method of claim 10, wherein the active agricultural ingredient and the adjuvant are mixed together to form an agricultural composition prior to application.

14. The method of claim 13, wherein the agricultural composition further comprises one or more of the following: water, pH adjusters, microbial inoculants, mineral sources, plant seeds, dyes, stabilizers, emulsifiers, prebiotics, polymers, buffering agents, viscosity modifiers, preservatives, nutrients for plant and/or beneficial microbe growth, tracking agents, biocides, surfactants, lubricants, solubility controlling agents, preservatives, and ultra-violet light resistant agents.

15. The method of claim 10, wherein application is carried out using an irrigation system.

16. The method of claim 10, wherein application is carried out by spraying.

17. A method of controlling a pest, which comprises applying a pesticide to the pest and/or its environment in the presence of an adjuvant composition according to claim 4.

18. The method of claim 17, wherein the pest is an arthropod, fungus, bacterium, or parasite.

19. The method of claim 17, wherein the adjuvant composition and the pesticide are mixed together prior to application.
